(19) United States
(12) Patent Application Publication
(10) Pub. No.: US 2026/0220704 A1
(43) Pub. Date: Jul. 30, 2026

(54) BLOCKCHAIN-BASED SYSTEM FOR ENFORCING COMPLIANCE IN SECONDARY TRADING OF FINANCIAL ASSETS

(71) Applicant: Nicholas Szerman, Sunny Isles Beach, FL (US)

(72) Inventor: Nicholas Szerman, Sunny Isles, FL (US)

(73) Assignee: Nicholas Szerman, Sunny Isles Beach, FL (US)

(21) Appl. No.: 18/889,259

(22) Filed: Sep. 18, 2024

(51) Int. Cl. G06Q 40/04; G06Q 30/018

(52) U.S. Cl. CPC G06Q 40/045; G06Q 30/018; G06Q 40/04

(57) ABSTRACT

The present system pertains to a blockchain-based method for enforcing compliance in secondary trading of financial assets. The system operates on a blockchain network supporting ERC-20 standard digital assets. A registration module enforces registration of asset holders with a platform. A modified transfer function, embedded in the ERC-20 standard smart contract, checks the registration status of asset recipients and signers. A detection module identifies and blocks illegal activities such as wash trading and tax avoidance. The system is compatible with a wide range of blockchains, including Ethereum, Arbitrum, Optimism, Base, Polygon, Avalanche, Binance chain, Tron, Linea, Kava, Solana, Blast, Algorand, ICP, Fantom, Metis, Polygon zkEVM, ZKsync Era, Aptos and all EVM or smart contract technology compatible chains.

### FIELD OF INVENTION

The present disclosure relates to blockchain technology, and more particularly to a system for enforcing compliance in secondary trading of financial assets on blockchain platforms.

### BACKGROUND

Blockchain technology has revolutionized the way digital transactions are conducted, providing a decentralized and secure platform for the exchange of digital assets. One of the primary features of blockchain technology is the use of smart contracts, which are self-executing contracts with the terms of the agreement directly written into code. These smart contracts allow for the automation of complex processes, reducing the potential for human error and increasing efficiency.

The Ethereum blockchain has gained popularity due to its support for smart contracts. Within the Ethereum ecosystem, the ERC-20 standard has emerged as a common set of rules for Ethereum tokens, allowing them to interact in a predictable way. The ERC-20 standard specifies a set of functions that the token contract can implement, including functions for transferring tokens, querying the balance of an address, and getting the total supply of tokens.

The ERC-20 standard has played a central role in the widespread adoption of blockchain technology. However, the ERC-20 standard has its limitations, particularly when it comes to complex compliance checks. Despite the simplicity and broad interoperability of the ERC-20 standard's basic functions, there has been hesitance by developers to modify these core functions.

Blockchain technology's application in the financial sector includes representing financial assets such as stocks, bonds, and commodities, as digital tokens. This application offers increased transparency, reduced transaction costs, and the potential for increased liquidity. Secondary market trading of these digital assets presents challenges, including compliance with KYC and AML regulations. KYC and AML checks and technologies are evolving to meet new regulatory requirements and combat sophisticated financial crimes. These checks are integral to the financial industry's efforts to prevent money laundering and ensure regulatory compliance.

Another challenge in digital asset trading is preventing illegal activities such as wash trading and tax avoidance. Wash trading creates misleading, artificial activity in the marketplace, while tax avoidance can be facilitated by the pseudonymous nature of blockchain transactions.

### SUMMARY

This summary is provided to introduce a selection of concepts in a simplified form that are further described below in the detailed description. This summary is not intended to identify features of the claimed subject matter, nor is it intended to be used as an aid in determining the scope of the claimed subject matter.

The foregoing summary, as well as the following detailed description of embodiments will be better understood when read in conjunction with the appended drawings. As used herein, an element or step recited in the singular and preceded by the word “a” or “an” can be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

The present disclosure provides a system for enforcing compliance in secondary market trading of financial assets. This system includes a blockchain network configured to facilitate the creation and transfer of digital assets, including those adhering to the ERC-20 standard. The system also includes a registration module comprising a processor and memory. The processor executes instructions stored in the memory to require asset holders to register with a designated platform.

The system further includes a modified transfer function within the ERC-20 standard smart contract. This function includes code executed by the blockchain network to verify the registration status of asset recipients and signers. Additionally, the system includes a detection module comprising a processor and memory. The processor executes instructions stored in the memory to proactively identify and prevent illegal activities, including but not limited to wash trading and tax avoidance.

In some embodiments, the registration module further includes a database to compile and maintain a deny list of wallets implicated in wash trading, along with any associated assets. In other embodiments, the detection module includes an algorithm executed by the processor to identify wash trading using a Pareto-Levy test. This test can characterize a user as engaging in wash trading if they account for 10% or more of the trading volume on a given exchange.

The present disclosure also provides a method for enforcing compliance in secondary market trading of financial assets on a blockchain. This method includes receiving a transfer request for an ERC-20 standard digital asset from a sender to a recipient by a computing system. The method also includes verifying the registration status of the recipient or the signer with a platform by the computing system. The method further includes executing the digital asset transfer upon confirmation of verified registration status by the computing system. The method also includes blocking the digital asset transfer if the registration status is unverified by the computing system.

In some embodiments, the method further includes detecting and preventing the use of wrapper contracts based on an analysis of trading patterns by the computing system. In other embodiments, the verification of registration status is conducted by examining a distinct set of contracts that may implement ERC-721 and ERC-1155 standards representing the identity of the recipient or the signer.

The present disclosure also provides a computer-readable medium containing instructions that, when executed by a processor, result in the receipt of a transfer request for an ERC-20 standard digital asset from a sender to a recipient on a blockchain. The instructions also result in the verification of the recipient's or signer's registration status with a platform. The instructions further result in the execution of the digital asset transfer upon verification of registration status. The instructions can also lead to the blocking of the digital asset transfer if the registration status is unverified.

In some embodiments, the verification of registration status is achieved by examining a separate set of contracts that may implement ERC-721 and ERC-1155 standards symbolizing the identity of the recipient or the signer. In other embodiments, the instructions further lead the processor to detect and prevent the use of wrapper contracts through an analysis of trading activities. In yet other embodiments, the instructions further lead the processor to enforce geographical restrictions on the transfer of the digital asset, thereby ensuring compliance with securities laws.

The present system can integrate compliance checks directly into the ERC-20 standard token's transfer mechanism, embedding mandatory adherence to regulatory laws such as KYC and AML within the smart contract code.

Moreover, the modified transfer function within the ERC-20 standard can enforce restrictions based on the recipient's attributes or the transaction's context, such as preventing transfers to unregistered or blacklisted addresses or enforcing geographical restrictions in compliance with securities laws. This level of control is not possible with the standard ERC-20 transfer function, which treats all transactions uniformly. Additionally, by introducing additional validation steps and controls, the modified transfer function enhances the security of the token, protecting against unauthorized access and ensuring that tokens are transferred in a manner consistent with the token issuer's intentions.

### BRIEF DESCRIPTION OF FIGURES

Non-limiting and non-exhaustive examples are described with reference to the following figures.

FIG. 1: A schematic diagram illustrating the overall architecture of the blockchain-based system for enforcing compliance in secondary trading of financial assets. This figure shows the blockchain network, the registration module, the modified transfer function, and the detection module.

FIG. 2: A flowchart illustrating the process for the registration and compliance enforcement process within the system, such as the registration module, including the steps for enforcing registration of asset holders with the platform and the process for denying listing wallets engaged in wash trading and their affiliated assets.

FIG. 3: A flowchart illustrating the modified transfer function's operation embedded in the ERC-20 standard smart contract, detailing the steps for checking the registration status of asset recipients and signers.

FIG. 4: A flowchart process for enforcing compliance in secondary market trading of financial assets, such as registration document confirmation and user registration.

FIG. 5: A diagram depicting a system process flow for enforcing compliance using the computer-based system.

FIG. 6. A diagram depicting a system process flow for enforcing compliance using the registration module.

### DETAILED DESCRIPTION

The present disclosure introduces a system that harnesses the power of blockchain technology to enforce compliance in the secondary trading of financial assets. This system is built upon the ERC-20 standard, a smart contract standard that has gained widespread acceptance and use in the blockchain domain. The system introduces modifications to the standard to enhance the security and efficiency of asset transactions.

The system addresses the limitations of secondary trading on open and/or permissionless platforms by utilizing a method to enforce holders to be registered with a platform while simultaneously allowing for secondary trading and liquidity. This is achieved by modifying the transfer function of the ERC-20 standard to check that either the recipient of the asset is an end-wallet registered with the platform, or if it's a contract, the signer is registered with the platform.

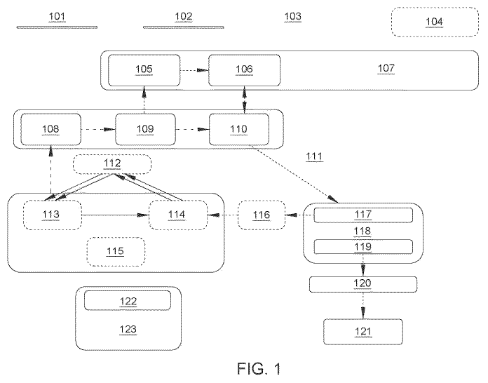

FIG. 1 provides a comprehensive view of the blockchain-based system for enforcing compliance in the trading of financial assets. The Blockchain Network 101 is the core infrastructure that enables the creation and transfer of digital assets, following the ERC-20 token standard. The Registration Module 102 is a central component that manages the registration of asset holders, ensuring they meet regulatory requirements. Within this module, the Processor 105, which can also be referred to as a CPU and components thereof, executes the registration process, while the Memory 106 stores registration data and instructions. The Database 107 serves as a repository for managing data related to registered asset holders and compliance information. The Detection Module 103, with its Processor 108 and Memory 109, executes algorithms to identify illegal activities such as wash trading. The Algorithm 110 within this module is specifically designed to detect patterns indicative of such activities. The Modified Transfer Function 111 is a specialized function within the ERC-20 smart contract 113 that includes additional code for compliance checks 104. The Verification Process 112 is the procedure by which the system verifies the registration status of asset recipients and signers. The ERC-20 Smart Contract 113 governs the transfer and management of digital assets, while the contract containing IDs 114 represents non-fungible tokens that symbolize user 1001 identities, which in some embodiments may be implemented by an ERC-721 contract. The Deny List 115 is maintained by the registration module 102 and contains wallets and associated assets identified as participating in illegal activities. The Geographical Restriction Module 116 enforces transfer restrictions based on the geographical location of transaction participants. The Smart Contract Wallet 117 is a digital wallet in the form of a smart contract that allows users and the platform to manage and transfer assets securely. The User 118 within the smart contract wallet 117 interacts with it to manage their digital assets, while the Platform 119 oversees the wallet and can perform authorized actions such as withdrawals. The Third-Party Cryptocurrency Exchange 120 is an external exchange platform from which the Platform 119 can withdraw assets into the smart contract wallet 117. The Asset 121 within the third-party cryptocurrency exchange 120 can be managed through the smart contract wallet 117. The Universal Orders System 122 integrates with the blockchain network 101 to provide additional information for constructing and executing asset transfer orders. The API Call 123 within the Universal Orders system 122 is a request made to an external service or data source to retrieve additional information for the system.

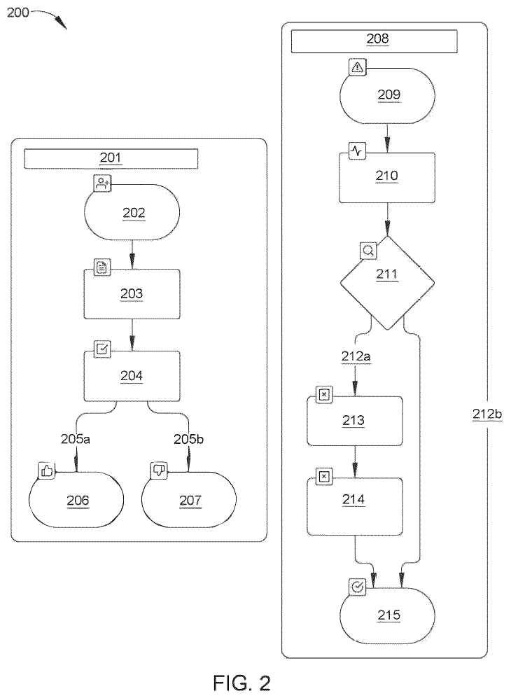

FIG. 2 illustrates the flowchart process 200 for the registration and compliance enforcement process within the system. The Initial Registration Module 201 marks the starting point where the user 1001 begins the registration process. The User Registration Step 202 involves the user 1001 providing personal and financial information for registration. The Verification of User Identity 203 is where the system verifies the user's identity against provided documents and data. The Compliance Check Step 204 is where the system performs compliance checks 1005 against regulatory standards. Depending on the outcome, the process may take the Path for Successful Compliance Check 205a if the user 1001 passes the compliance check, or the Path for Failed Compliance Check 205b if the user 1001 fails. The Approval of Transaction 206 is granted following a successful compliance check, while the Rejection of Transaction 207 occurs if the compliance check fails. The Detection Module 208 is responsible for monitoring and identifying potential illegal trading activities. The Detection of Illegal Activities 209 is where the system identifies activities such as wash trading or tax avoidance. The Analysis of Trading Patterns 210 examines trading data to detect suspicious or illegal patterns. The Decision Point for Detecting Illegal Activities 211 is where the system decides whether illegal activities are present. If illegal activities are detected, the process takes the Path for Detected Illegal Activities 212a, leading to the Detection of Transaction for Illegal Activities 213 and then Manual Review for Illegal Activities 214. At Manual Review for Illegal Activities 214 the transaction can be manually rejected or moved to Final Compliance Confirmation 215, in which the transaction can be accepted. If no illegal activities are detected in the initial stage at Decision Point for Detecting Illegal Activities 211, the process takes the Path for No Illegal Activities Detected 212b, allowing the Continuation of Transaction to the Final Compliance Confirmation 215, which is the concluding step where the system confirms compliance before finalizing a transaction.

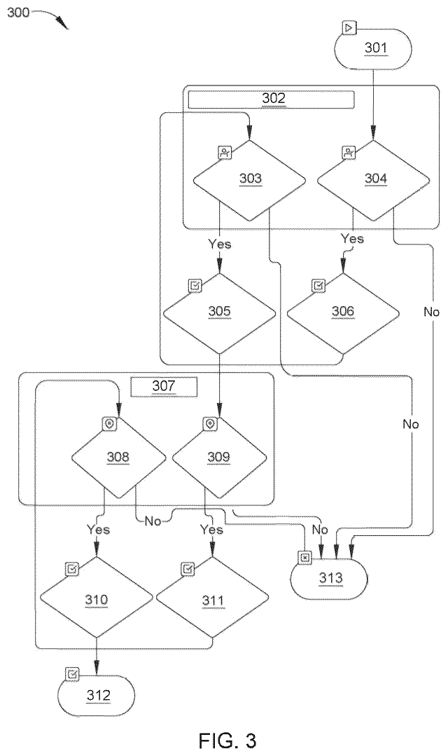

FIG. 3 presents the 300 process flow for the operation of the modified transfer function 301 within the ERC-20 standard smart contract. The Initial Verification Step 302 is where the system begins to verify the registration status of participants. The system checks whether the recipient of the asset is registered in the Check Recipient Registration Status 303 and whether the signer of the transaction is registered in the Check Signer Registration Status 304. If the recipient's and signer's registration is confirmed in steps Confirm Recipient Registration 305 and Confirm Signer Registration 306, respectively, the process moves to Handle Verified Registrations 307. The system identifies potential illegal activities related to the transaction in the Detect Illegal Activities 308 and identifies the use of wrapper contracts that may circumvent compliance checks 312 in the Detect Use of Wrapper Contracts and/or asset proxying mechanisms 309. If illegal activities, unauthorized activities, asset proxying mechanisms, and/or wrapper contracts are detected, the system can block the transaction in steps Block Transfer if Illegal Activities Detected 310 and Block Transfer if Wrapper Contracts Detected 311, respectively. This detection of illegal and/or unauthorized activities could be done with off-chain or on-chain methods, in real time, and/or after the fact via manual review. Upon successful completion of these steps, the process 300 concludes with step 312, where the system notifies relevant parties about the transaction outcome.

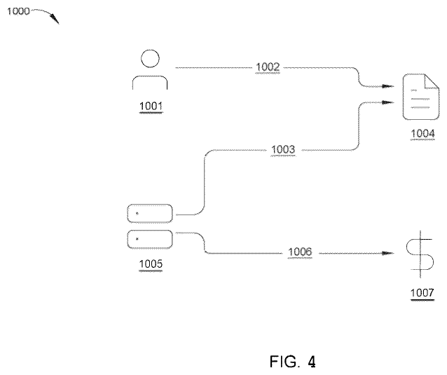

FIG. 4 presents a flowchart process 1000 for enforcing compliance in secondary market trading of financial assets. The User 1001 initiates the User Registration Process 1002, followed by the Verification Process 1003 to ensure compliance with regulatory standards. The Registration Confirmation Document 1004 verifies the successful registration of the user 1001. The system performs Compliance Checks 1005 to ensure that the user 1001 and the transaction comply with regulatory requirements. The Financial Transaction Execution 1006 involves the transfer of a Financial Asset 1007 on the blockchain platform.

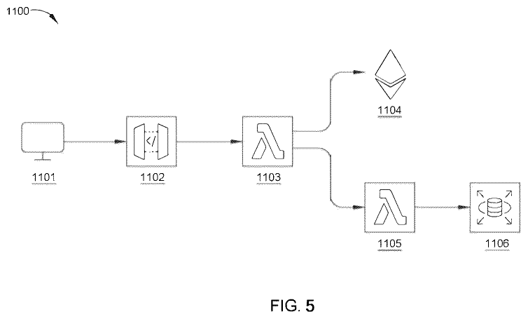

FIG. 5 depicts the system process flow 1100 for enforcing compliance. The User Interface 1101 allows users to interact with the system. The Code Execution Module 1102 executes the code for compliance enforcement. The Computer 1103 is a serverless computing service that manages computing resources. The Ethereum Blockchain 1104 is the specific blockchain platform on which the system operates. The Function 1105 represents an algorithm for enforcing compliance. The Database 1106 stores compliance enforcement and user 1001 registration information.

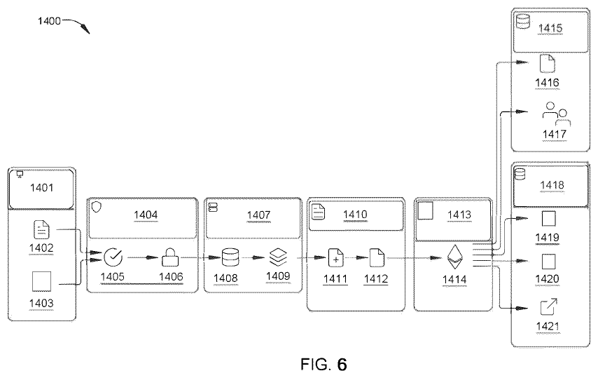

FIG. 6 illustrates the system process flow 1400 for compliance enforcement. The Registration Module 1401 initiates the registration process. The Document Verification Step 1402 verifies documents. The Identity Verification Step 1403 confirms user 1001 identities. The Security Check Module 1404 performs security checks. The Approval Check Step 1405 determines user 1001 approval. The Compliance Lock Mechanism 1406 restricts transactions. The Transaction Processing Module 1407 processes transactions. The Database Storage Step 1408 stores transaction data. The Asset Management Step 1409 manages assets. The Transaction Verification Module 1410 verifies transaction details. The Addition of Transaction Details 1411 and Validation of Transaction Details 1412 ensure transaction compliance. The Asset Transfer Module 1413 facilitates asset transfers on the blockchain network 1414. The server 1415 may be a server configured to store and process data. The database 1416 may be a database configured to store data. The user management module 1417 may be a module configured to manage user accounts, user permissions, or any other aspects of user management.

The system also includes a monitoring tool 1418, which comprises performance metrics 1419, error logs 1420, and an update mechanism 1421.

The monitoring tool 1418 may be a tool configured to monitor the performance of the system, to log errors, or to perform updates. The performance metrics 1419 may include metrics such as the system's processing speed, the system's uptime, or any other metrics related to the system's performance. The error logs 1420 may include logs of any errors that occur during the operation of the system. The update mechanism 1421 may be a mechanism configured to update the system's software, the system's hardware, or any other aspects of the system.

The system's blockchain-based structure, referred to as a “blockchain-based system” is a system designed to enforce compliance in secondary trading of financial assets. It includes several components such as a blockchain network 101, a registration module 102, a modified transfer function 111, and a detection module 103, all working in conjunction to ensure secure and efficient asset transactions.

The system operates on a blockchain network 101 that supports the creation and transfer of digital assets, such as the ERC-20 standard. The ERC-20 standard, a widely adopted smart contract standard in the blockchain space, provides a set of functions that allow for the creation, transfer, and management of digital assets on the blockchain. These functions include, but are not limited to, transferring assets, approving third parties to spend assets, checking the balance of assets, and determining the total supply of assets.

In some embodiments, the blockchain network 101 may be a public blockchain network, such as Ethereum, that allows anyone to participate and interact with the network. In other embodiments, the blockchain network 101 may be a private or consortium blockchain network, where participation is restricted to a specific group of entities. The choice of blockchain network 101 may depend on various factors, including the desired level of security, transparency, and control over the digital assets.

In some embodiments, the blockchain network 101 may be configured to support the creation and transfer of a wide range of digital assets. These assets may represent various types of financial assets, such as stocks, real estate, bonds, commodities, or cryptocurrencies. The digital representation of these assets on the blockchain allows for efficient and secure transactions, while also providing transparency and traceability.

In some embodiments, the blockchain network 101 may be compatible with other blockchain standards or protocols, in addition to the ERC-20 standard. For example, the network may support the ERC-721 standard for non-fungible tokens, the ERC-1155 standard for multi-token contracts, or other standards that may be developed in the future. This compatibility with multiple standards allows the system to handle a wide variety of digital assets, enhancing its versatility and applicability across different financial sectors.

In some embodiments, the blockchain network 101 may be configured to interact with other systems or technologies. For instance, the network may be integrated with existing financial systems, identity verification services, or third-party blockchain monitoring solutions. This integration can enhance the functionality of the system, allowing it to provide additional services or features, such as enforcing KYC or AML regulations, detecting illegal activities, or facilitating the registration of users.

The system includes registration module 102 configured to enforce registration of asset holders with the platform. The registration module 102 may be designed to ensure that all holders of the ERC-20 standard digital assets are registered with the platform before they can engage in secondary trading or liquidity provision. This registration process may involve the submission of personal information, such as name, contact details, and identification documents, to the platform for verification. In some cases, the registration module 102 may also require the asset holders to agree to terms and conditions, such as compliance with KYC and AML regulations, before they can be registered.

In some embodiments, the registration module 102 may be implemented as a smart contract on the blockchain network 101. The smart contract may be programmed to automatically enforce the registration requirements whenever a transfer of digital assets is initiated. For instance, the smart contract may check the registration status of the sender and the recipient of the assets, and block the transfer if either party is not registered with the platform.

In some embodiments, the registration module 102 may also be configured to maintain a registry of registered asset holders. This registry may include information such as the wallet addresses of the asset holders, their registration status, and any other relevant information. The registry may be stored on the blockchain network 101, making it accessible to other modules.

In some embodiments, the registration module 102 may be configured to handle updates to the registration information. For instance, if an asset holder changes their contact details or identification documents, the registration module 102 may allow them to update their registration information accordingly. The module may also handle deregistration requests, allowing asset holders to remove themselves from the registry if they no longer wish to hold the ERC-20 standard digital assets.

In some embodiments, the registration module 102 may be configured to interact with other components of the system, such as the modified transfer function 111 and the detection module 103. For instance, the registration module 102 may provide the modified transfer function 111 with the registration status of the asset holders, enabling the function to enforce the registration requirements. Similarly, registration module 102 may provide the detection module 103 with the registry of registered asset holders, enabling the module to identify and block illegal activities.

The following disclosure provides details on the functionality and operation of this aspect of the blockchain-based system for enforcing compliance in secondary trading of financial assets.

The registration module 102 is a component of the blockchain-based compliance system that serves to register and track the status of asset holders on the platform. A component of this module is a database 1106 specifically designed to compile and maintain a deny list 115. This deny list 115 is a record of wallets that have been identified as participating in wash trading or other illegal activities, as well as any assets associated with these wallets.

The database 1106 within the registration module 102 is structured to store a wide range of data related to compliance enforcement. This includes the wallet addresses of users, the registration status of each user 1001, and a history of their transactions. When the system identifies wallets that are involved in wash trading, these wallets, along with details of the associated assets, are added to the deny list 115 within the database 1106.

The deny list 115 is actively managed by the registration module 102 to ensure its accuracy and effectiveness. The module's processor executes instructions to update the deny list 115 in real-time as new instances of wash trading are detected. The database 1106 is also capable of associating implicated wallets with their corresponding assets, ensuring that all relevant information is captured and maintained.

The registration module's database 1106 is integrated with the detection module 103 of the system. When the detection module 103 identifies potential wash trading activity, it communicates this information to the registration module 102, which then updates the deny list 115 accordingly. This integration ensures that the system can respond quickly to illicit activities and enforce compliance measures effectively.

The database 1106 is secured with access control mechanisms to protect the integrity of the deny list 115. Authorized personnel or systems have the ability to modify the deny list 115, preventing unauthorized changes or deletions. Additionally, database 1106 may employ encryption to safeguard the data against unauthorized access or breaches.

The registration module's database 1106 can generate reports based on the deny list 115 for regulatory authorities. These reports provide evidence of the platform's compliance efforts and can be used in investigations or audits. In some embodiments, the system can automatically generate and submit these reports at regular intervals or upon request from regulatory bodies.

The database's ability to associate wallets with their corresponding assets allows the system to track the flow of assets implicated in wash trading. This tracking capability is particularly useful for preventing the circulation of illegal assets within the platform and for aiding in the recovery of assets as part of legal proceedings.

When a wallet is added to the deny list 115, the registration module 102 can notify the affected user 1001 and provide them with information on the reasons for the action taken. The module may also include a mechanism for users to appeal the decision, offering a process for reviewing and potentially removing wallets from the deny list 115 if user 1001 can demonstrate compliance.

The system includes a modified transfer function 111 embedded in the ERC-20 standard smart contract. The modified transfer function 111 may be designed to check the registration status of asset recipients and signers, thereby enforcing compliance with registration requirements during asset transactions.

In some embodiments, the modified transfer function 111 may be implemented as a part of the ERC-20 standard smart contract. The ERC-20 standard smart contract, which defines the features of the digital asset, may be programmed to include the modified transfer function 111 as one of its features. This integration of the modified transfer function 111 into the ERC-20 standard smart contract may allow for seamless enforcement of registration requirements during asset transactions, without the involvement of a separate third-party contract.

In some embodiments, the modified transfer function 111 may be configured to check the registration status of the recipient of the asset. If the recipient is an end-wallet, the function may verify that the end-wallet is registered with the platform. This may involve checking a registry of registered end-wallets, which may be maintained by registration module 102. If the recipient is not registered with the platform, the modified transfer function 111 may block the transfer of the asset.

In other embodiments, if the recipient of the asset is a contract, the modified transfer function 111 may check the registration status of the signer of the contract. The signer, who may be the entity initiating the contract, may be verified to be registered with the platform. If the signer is not registered with the platform, the modified transfer function 111 may block the transfer of the asset.

In some embodiments, the modified transfer function 111 may be configured to enforce other restrictions or conditions during asset transactions. For instance, the function may enforce geographical restrictions, preventing the transfer of assets to countries where such trade is illegal. The function may also enforce limits on the number or value of assets that can be transferred, preventing excessive or suspicious transactions.

In some embodiments, the modified transfer function 111 may be coded in a programming language suitable for smart contracts, such as Solidity. The use of such a programming language may allow for efficient and secure implementation of the function, ensuring its compatibility with the blockchain network 101 and the ERC-20 standard smart contract.

The system includes a registration module 102 configured to deny list 115 wallets that are engaged in wash trading along with all their affiliated assets. Wash trading is a type of market manipulation where an investor simultaneously buys and sells the same financial instruments to create misleading, artificial activity in the marketplace. This deceptive practice can distort the true supply and demand dynamics of financial instruments, leading to inaccurate pricing and unfair trading conditions.

Upon detection of wash trading, the registration module 102 may add the implicated wallet to a deny list 115. The deny list 115 may be a registry of wallets that are prohibited from participating in secondary trading or liquidity provision due to their involvement in illegal activities. The deny list 115 may be stored on the blockchain network 101, ensuring its immutability and transparency.

In addition to the implicated wallet, the registration module 102 may also deny list 115 all assets affiliated with the wallet. These affiliated assets may include other ERC-20 standard digital assets that are owned by the same entity or are linked to the implicated wallet in some way. By deny-listing these affiliated assets, the system may prevent the entity from circumventing the restrictions by transferring the assets to a different wallet.

In some embodiments, the registration module 102 may also be configured to handle updates to the deny list 115. For instance, if a wallet is found to have ceased its involvement in wash trading, the registration module 102 may remove the wallet from the deny list 115. Similarly, if new wallets are found to be engaged in wash trading, the registration module 102 may add these wallets to the deny list 115. This adaptability may ensure that the system remains effective in enforcing compliance and preventing illegal activities.

In other embodiments, the registration module 102 may be configured to interact with other components of the system, such as the modified transfer function 111 and the detection module 103. For instance, the registration module 102 may provide the modified transfer function 111 with the deny list 115, enabling the function to block transactions involving deny listed wallets or assets. Similarly, the registration module 102 may provide the detection module 103 with the deny list 115, enabling the module to focus its detection efforts on non-deny listed wallets and assets.

In some embodiments, the request to transfer the digital asset may be initiated by the sender, who may be the current holder of the asset. The sender may specify the recipient, who may be the intended new holder of the asset, and the number of assets to be transferred. The request may be submitted to the blockchain network 101, where it may be processed by the modified transfer function 111 of the ERC-20 standard smart contract.

In some cases, the request to transfer the digital asset may be associated with a transaction on the blockchain. This transaction may represent the purchase or sale of the asset, depending on the nature of the asset and the direction of the transfer. For instance, if a currency is sent, the transaction may represent a purchase of the asset, whereas if the asset token is sent, the transaction may represent a sale of the asset.

In other cases, the request to transfer the digital asset may be associated with a secondary trade on a decentralized exchange. In a secondary trade, the asset is not directly bought or sold against the issuer, but rather traded between users on the exchange. This allows for greater liquidity and flexibility in the trading of the asset, as users can trade the asset at any time and at market prices.

In yet other aspects, the system may process the request to transfer the digital asset by executing a corresponding broker order. The broker order may be generated based on the request and supplemental information obtained via an API call to a server. This supplemental information may be paired with the corresponding blockchain transaction to construct the desired order. This process, referred to as the Universal Orders system 122, allows the system to generate orders that require information beyond what the ERC-20 standard commonly allows, thereby enhancing the flexibility and efficiency of asset transactions.

In some aspects, the system may process requests to transfer digital assets by executing broker orders, which are generated based on the initial request and supplemental information obtained via an API call to a server. The supplemental information may include data such as current market prices, liquidity levels, historical trading volumes, or other relevant financial data that can influence the execution of the order. This information is paired with the corresponding blockchain transaction to construct the desired order, ensuring that the order reflects the current market conditions and the intentions of the user 1001.

The broker order flow methods may vary depending on several factors, including the type of digital asset being traded, the specific requirements of the user 1001, and the regulatory environment.

In the context of broker order flow methods, a range of strategies may be employed to execute trades effectively. Direct order execution allows the system to carry out the broker's order on either a decentralized exchange (DEX) or a centralized exchange (CEX) where the digital asset is available. The execution could be immediate at the prevailing market price, known as a market order, or at a predetermined price specified by the user 1001, known as a limit order. Other broker order flow methods such as Smart Order Routing, auction based orders, conditional orders, Algorithmic trading, or P2P matching could also be utilized.

For larger broker orders, the system may integrate with over-the-counter (OTC) trading desks. These desks are adept at privately managing substantial trades and can offer liquidity and pricing that might not be accessible on public exchanges.

In scenarios where the broker's order involves assets across different blockchains, the system may facilitate cross-chain swaps. This is achieved using atomic swaps or other interoperability protocols, allowing users to exchange assets across various blockchain networks without relying on a centralized intermediary.

In some embodiments, the system may further extend the broker order flow methods to facilitate backend stock purchases using blockchain contracts as representations of real stocks. This approach allows for the tokenization of traditional securities, enabling them to be traded on the blockchain with enhanced liquidity and efficiency.

The process begins with the tokenization of stocks, where each share of a stock is represented by a corresponding digital token on the blockchain. These tokens are designed to mirror the ownership and rights associated with the actual stocks, including dividends, voting rights, and other shareholder privileges. The tokenization process involves creating a smart contract on the blockchain that defines the rules and characteristics of the stock tokens, ensuring that they comply with regulatory standards and represent the underlying stocks accurately.

Once the stocks are tokenized, users can initiate broker orders to purchase these digital representations of stocks through the system. The broker orders are generated based on the user's request and may include supplemental information such as the current market valuation of the stocks, historical performance data, and regulatory compliance requirements. This information is obtained via an API call to a server that aggregates financial market data and regulatory information.

The system in question is designed to process broker orders for stock tokens using a variety of methods, each tailored to accommodate the distinct attributes of these digital assets.

Integration with securities exchanges or alternative trading systems (ATS) is one such method. The system may link with these traditional platforms that are equipped to handle the trading of tokenized stocks. By executing broker orders on these platforms, users gain access to the liquidity and established market infrastructure of the conventional financial markets. Another approach involves decentralized securities or P2P trading platforms.

The system may also utilize compliance-enforcing smart contracts. These are programmed to uphold securities regulations during the execution of broker orders. The smart contracts conduct automated checks to confirm that all transactions comply with KYC, AML, and other regulatory requirements, thus ensuring a compliant trading environment for tokenized stocks.

For users who necessitate custodian services for their tokenized stocks, the system can integrate with custodial service providers. These custodians offer secure storage and management of digital assets. As part of the broker order flow, stock tokens may be transferred to the custodian's wallet after the trade is completed, which guarantees secure custody of the assets.

The system may also feature mechanisms for the distribution of dividends to tokenized stockholders. Smart contracts can be programmed to automatically calculate and distribute dividends to stock token owners, thereby simplifying the process for both the issuing companies and the shareholders.

Lastly, the system is capable of supporting the execution of corporate actions, such as stock splits or mergers, through the use of smart contracts. These contracts can autonomously adjust the tokenized stock holdings of users in accordance with the corporate actions, ensuring that the digital representation of the stocks remains accurate and intact.

In some aspects, a technical software architecture for using blockchain to represent real-world assets such as stocks involves several layers, each responsible for handling specific aspects of the system's functionality, is described. The architecture is designed to ensure that the digital representation of stocks on the blockchain reflects the value, ownership, and rights associated with the real-world assets.

The first layer is the Asset Tokenization Layer, where real-world assets such as stocks are converted into digital tokens on the blockchain. This involves creating a digital twin of the asset that captures its inherent characteristics, such as ownership rights, value, and dividends. The tokenization process is governed by smart contracts that define the rules and logic for the issuance, transfer, and management of these tokens.

The software architecture for the Asset Tokenization Layer may include a blockchain platform that supports smart contract functionality, such as Ethereum. This platform allows for the creation of digital tokens that represent real-world assets, with smart contracts defining the rules and logic for these tokens. The architecture may also include a user interface 1101 for asset issuers to manage the tokenization process and for investors to view and trade tokens.

The programming details for this layer may involve using Solidity, the primary language for writing smart contracts on Ethereum. Developers may use frameworks like Truffle or Hardhat for testing and deploying contracts. The user interface 1101 could be built using JavaScript frameworks such as React or Vue.js, with web3.js or ethers.js libraries to interact with the Ethereum blockchain 1104.

The Asset Tokenization Layer may utilize various software technologies to create a digital representation of real-world assets on the blockchain. This layer is responsible for converting the rights associated with these assets into digital tokens that can be traded, transferred, and managed on the blockchain. In some embodiments, the asset tokenization layer may be built using blockchain platforms such as Ethereum, which supports smart contract functionality.

For the development and deployment of smart contracts, the asset tokenization layer may employ development frameworks such as Truffle Suite, which provides a development environment, testing framework, and asset pipeline for blockchain applications. Truffle's suite of tools facilitates the compilation, migration, and testing of smart contracts, streamlining the development process. Additionally, the asset tokenization layer may integrate with the InterPlanetary File System (IPFS) for storing off-chain asset data that is too large or not suitable for on-chain storage. IPFS provides a decentralized storage solution that can store data securely and efficiently, making it accessible to smart contracts via content identifiers (CIDs).

For the front-end interface that interacts with the asset tokenization layer, web3.js or ethers.js libraries may be used. These JavaScript libraries allow web applications to communicate with the Ethereum blockchain 1104, enabling users to manage and interact with tokenized assets through a web browser.

In the present invention, a blockchain contract can be created that allows an issuer to create a new tokenized asset with a specified initial supply and provides functions to tokenize additional assets and redeem tokens. The contract could be extended with additional logic to handle asset details and redemption processes.

The second layer is the Smart Contract Layer, which includes the modified ERC-20 contract transfer function. In some embodiments of the invention, the Smart Contract Layer could be an element of the Blockchain Layer and/or Asset Tokenization Layer, rather than a separate layer of the software architecture. This function is enhanced to include additional checks that verify the compliance of transactions with regulatory requirements. For instance, the modified transfer function 111 may include logic to verify the identity of the participants in a transaction, ensuring adherence to Know Your Customer (KYC) and Anti-Money Laundering (AML) regulations. The function may also enforce restrictions based on geographical location or trading limits to comply with securities laws.

The Smart Contract Layer of the system is a foundational component that encompasses the modified ERC-20 contract transfer function. This layer is responsible for the execution of smart contract code that facilitates the transfer of digital assets while enforcing compliance with regulatory requirements.

Central to the layer is the Smart Contract Core, which houses the primary smart contract code that delineates the logic governing asset transfers. Within this core is a modified transfer function 111 that integrates extra checks for registration status and compliance enforcement, ensuring that asset transfers meet regulatory requirements.

The Compliance Verification Component works in tandem with the modified transfer function 111 to validate the compliance of each transaction. It has the capability to invoke external modules or services to conduct KYC/AML checks, thereby confirming that all asset transfers are in line with the prevailing regulatory standards.

Another integral part of the architecture is the Data Access Component. Its role is to interface with the blockchain for the purpose of retrieving and storing pertinent data related to asset transfers. This includes information such as transaction histories, wallet addresses, and registration statuses, which are all instrumental in maintaining a compliant transfer process.

The Event Handling Component is designed to monitor and act upon events that the smart contract emits. These events could range from successful asset transfers to compliance violations. Upon detection of such events, this component can initiate notifications or other actions as appropriate.

To maintain the Smart Contract Layer's effectiveness over time, an Upgradeability Proxy may be incorporated. This feature enables updates to the contract logic without necessitating a change to the contract address or impacting the assets stored within it, thus preserving the integrity and continuity of the smart contract. The smart contracts in this layer are deployed to the blockchain, where they become immutable and self-executing. They interact with the blockchain's consensus mechanism to validate and record transactions.

While the Smart Contract Layer is commonly implemented using Solidity, there are alternative programming languages that can be utilized for writing smart contracts on the Ethereum blockchain 1104 or other blockchain platforms. For example, Vyper, which is reminiscent of Python, offers an alternative to Solidity for the creation of contracts with sophisticated logic and state. Additionally, programming languages such as Rust and Go could be employed for developing smart contracts on blockchain platforms that are compatible with the WebAssembly (WASM) virtual machine.

In terms of smart contract standards, the system predominantly adopts the ERC-20 standard. However, depending on the system's specific requirements, other Ethereum token standards could be employed. The ERC-721 standard, for instance, is suitable for contracts that represent uniquely identifiable assets, such as non-fungible tokens. The ERC-1155 standard is another option that facilitates the creation of both fungible and non-fungible tokens within a single contract, allowing for more intricate asset representations.

To improve the scalability and efficiency of the smart contracts, the Smart Contract Layer could incorporate Layer 2 solutions like Optimistic rollups or Zero Knowledge rollups. These solutions handle transactions off-chain and subsequently record the outcomes on the blockchain. This approach alleviates the burden on the Ethereum network and enables transactions that are both faster and more cost-effective.

The system's smart contracts could also be integrated with oracle services, which provide access to external, real-world data that is not inherently available on the blockchain. Oracles are external services that supply smart contracts with information such as market prices, weather conditions, or other types of off-chain data. This integration could expand the functionality of the smart contracts, allowing them to respond to real-world events or conditions.

Lastly, the smart contracts in the system could be integrated with decentralized identity solutions to bolster the privacy and security of user 1001 identities.

The third layer is the Compliance Verification Layer, which interacts with the modified transfer function 111 to enforce regulatory compliance. This layer may use algorithms and data analysis to monitor transactions for signs of illegal activities such as wash trading or insider trading. Upon detecting suspicious activity, the compliance verification layer can trigger the modified transfer function 111 to block the transaction and alert regulatory authorities if appropriate.

The Compliance Verification Layer may utilize various software technologies to ensure that transactions involving digital assets comply with regulatory standards. This layer is responsible for implementing the logic that monitors, verifies, and enforces compliance with laws and regulations during asset transfers on the blockchain.

Central to this layer is the Compliance Rules Engine, which houses the logic for a variety of compliance checks 1005. This engine scrutinizes transaction data against a set of established rules to ascertain whether a transaction adheres to compliance standards.

Another component, the Data Analysis Component, is tasked with the examination of transaction data. Its purpose is to identify patterns that could suggest non-compliance, such as wash trading or insider trading, which are red flags in the regulatory context.

The layer is also equipped with a Regulatory Database 1106 Interface, which serves as a bridge to external regulatory databases. This interface is responsible for retrieving the latest compliance requirements and updating the rules engine to reflect these changes, ensuring that the system remains current with regulatory demands.

Additionally, the Transaction Monitoring Component plays a vigilant role by overseeing blockchain transactions in real-time. It is programmed to flag any transactions that appear to breach compliance rules, marking them for further examination.

Lastly, the Reporting and Alerting Module is a component of the architecture. It is responsible for compiling reports on the compliance checks 1005 and issuing alerts to system administrators or regulatory authorities when it detects potential instances of non-compliance. This module ensures that any issues are promptly communicated and can be addressed in a timely manner.

The Compliance Verification Layer is typically implemented using programming languages that are suitable for backend development, such as Java, Python, or Node.js. These languages provide the robustness and flexibility to handle complex data analysis and integration with external systems.

The layer may employ machine learning algorithms to enhance the detection of non-compliant activities. Libraries such as TensorFlow or scikit-learn can be used to implement these algorithms, which can learn from historical data to identify patterns indicative of non-compliance.

For data storage, the layer may use databases that are optimized for fast read and write operations, such as NoSQL databases like MongoDB or distributed ledgers if immutability is a concern.

In some aspects, the system may include additional compliance checks 1005 to further enhance the security and integrity of financial asset 1007 transactions. These additional checks may be integrated into the smart contract logic to automatically assess and enforce compliance with a broader range of regulatory requirements and risk factors.

For instance, the system may implement checks for unusual transaction patterns that could indicate market manipulation or insider trading. It may also verify the accreditation status of investors to ensure that they are qualified to participate in the trading of specific financial instruments, as per regulatory guidelines.

Furthermore, the system may conduct real-time analysis of transaction data against global sanctions lists to prevent transactions with individuals or entities that are subject to regulatory restrictions. It may also enforce adherence to international trade laws by blocking transactions that involve countries or regions under trade embargoes.

Within the Compliance Module, a variety of additional compliance checks 1005 could be implemented to ensure the system's adherence to regulatory standards. These checks would enhance the robustness of the system's compliance framework. One such check is the Investor Accreditation Check, which verifies whether the sender of a transaction is an accredited investor. This check is especially pertinent for transactions that involve securities not traded on public markets. Another check is the Sanctions List Check, where the recipient's identity is cross-referenced with global sanctions lists. This step ensures that the system does not engage in transactions with prohibited individuals or entities. Additional compliance checks 1005 that could be implemented include, but are not limited to, trade embargoes checks, transaction pattern analysis, volume and price anomaly detection.

These checks are examples of the measures that could be integrated into the Compliance Module to bolster its compliance capabilities. By incorporating these additional compliance checks 1005, the system can provide a more comprehensive and robust framework for ensuring the legality and integrity of financial asset 1007 transactions on the blockchain.

To detect wash trading based on trading history, the ‘detect_wash_trading’ function may analyze the frequency, timing, and size of trades made by a sender and recipient.

The ‘detect_wash_trading’ function is designed to scrutinize the trading history between a sender and recipient by examining the frequency, timing, and size of their trades. This function is equipped with various analytical tools and logic to identify potential wash trading activities.

One aspect of the analysis involves looking for high-frequency trading patterns, where a sender and recipient execute a large number of trades in a short period. This could suggest that they are transferring the same asset back and forth to simulate market activity.

The function also checks for simultaneous buy and sell orders for the same asset at comparable prices and times. Such occurrences may indicate an attempt to manipulate the market.

Another area of focus is the identification of self-matching orders, where the sender and recipient may be the same entity or controlled by the same entity. This practice is commonly used in wash trading to generate artificial trading volume. The function conducts a profit and loss analysis on the trades between the sender and recipient. If the trades result in no substantial change in position or a loss, it could be indicative of a wash trading scheme.

Circular trading patterns are also scrutinized by the function. It looks for sequences of trades that start and end with the same party, a technique often employed to artificially inflate trade volumes. Scenarios where the trading volume between a sender and recipient is out of proportion with their historical trading patterns or the overall market volume for the asset are flagged by the function as potential wash trading.

Account linkage analysis is another tool used by the function to determine if multiple accounts are collaborating to conduct wash trades. This analysis may involve the examination of IP addresses, transaction patterns, or other identifying information that suggests linkage between different accounts. The function also compares the trade prices between the sender and recipient with prevailing market prices. Consistent execution of trades at prices that vary from the market average could signal wash trading. By implementing these analytical tools and logic, the ‘detect_wash_trading’ function aims to provide a comprehensive mechanism for detecting and preventing wash trading activities.

The fourth layer is the Data Storage and Management Layer, which securely stores transaction records, token ownership details, and compliance-related information. This layer may utilize blockchain's inherent immutability to ensure that records cannot be altered, providing a transparent and tamper-proof audit trail. The Data Storage and Management Layer may be implemented using a combination of blockchain technology and traditional database 1106 systems to ensure secure and efficient storage of transaction records, token ownership details, and compliance-related information. This layer is designed to leverage the immutability and transparency of blockchain for storing records that benefit from tamper-proof audit trails, while also utilizing the scalability and flexibility of traditional databases for data that requires more frequent and complex querying.

At the heart of the architecture is the Blockchain Ledger, a decentralized ledger that meticulously records all transactions and changes in token ownership. The ledger's decentralized nature, maintained across multiple network nodes, ensures that the data is redundant and resistant to tampering, providing a robust foundation for the system's integrity.

For data that does not necessitate the immutability characteristic of the blockchain, an Off-Chain Database 1106 is employed. This database 1106 could be one of several types, such as PostgreSQL, MongoDB, or MySQL. It is capable of storing larger data sets and supports complex queries with greater efficiency than blockchain-based storage solutions.

To enhance performance, a Data Caching Layer may be utilized. Systems like Redis or Memcached serve as temporary storage for frequently accessed data, which helps to alleviate the demand on the primary database 1106 and the blockchain, thereby improving the system's responsiveness.

Data Encryption is an aspect of the architecture, safeguarding sensitive information both during transmission and while stored. The management of encryption keys is a task that may be entrusted to secure vault services or hardware security modules, ensuring that the data remains protected against unauthorized access.

An API Layer is another component of the architecture, providing a conduit for communication between the blockchain, the off-chain database 1106, and other system components. This layer might employ RESTful APIs or GraphQL, offering a standardized method for data access and manipulation.

Database 1106 Management is also utilized and involves the creation of database 1106 schemas and the writing of management scripts, which could be in SQL or through an object-relational mapping tool, to facilitate off-chain database 1106 operations.

Data Security includes implementation of access controls, authentication mechanisms, and audit logging. These security measures can be programmed using languages such as Python, Java, or Node.js.

Lastly, Data Synchronization mechanisms are developed to ensure that the data remains consistent between the blockchain and the off-chain database 1106. This may include the use of event listeners that activate data updates in response to the addition of new blocks to the blockchain.

The fifth layer is the Integration Layer, which allows the system to connect with external data sources, services, and platforms. This may include traditional stock exchanges, regulatory databases, and third-party verification services. The integration layer ensures that the system has access to up-to-date market data and regulatory information.

The Integration Layer serves as a bridge between the blockchain-based system and external data sources, services, and platforms. It is designed to facilitate the seamless exchange of information, ensuring that the system has access to the latest market data and regulatory information, which is integral for accurate asset representation and compliance enforcement.

The software architecture of the Integration Layer may include components such as API gateways, middleware, and service connectors that enable communication and data exchange with external systems. The architecture is designed to be scalable and secure, with the ability to handle high volumes of data and support multiple data formats and protocols.

The Integration Layer of the system architecture 1200 is composed of several components that work together to facilitate seamless interaction with external data sources. API Gateways function as the primary entry point for these external data sources. They provide a secure and standardized method for the system to access external APIs. To optimize the flow of data, API Gateways may be equipped with features such as rate limiting, which controls the number of requests sent to the API within a given timeframe, caching, which temporarily stores data to reduce repeated API calls, and request transformation, which modifies incoming requests into a format suitable for the system.

Middleware serves as an intermediary layer that processes data transactions between the system and external services. This layer can be composed of various elements, such as message queues that allow for asynchronous data processing, ensuring that data handling does not interfere with the system's performance. Additionally, data transformation services are included to convert data into the desired format for use within the system, and integration brokers are utilized to manage and direct the flow of data efficiently.

Service Connectors are specialized modules designed to enable direct integration with specific external services. These services could range from stock exchanges to regulatory databases. Service Connectors may consist of custom adapters or plugins that are capable of translating the system's requests into a format that is compatible with the external service's API, ensuring smooth communication and data exchange.

When it comes to the programming aspects of the Integration Layer, various languages and frameworks are employed, each chosen for their strengths in building robust integration solutions.

Java is a popular choice in enterprise integration due to its extensive ecosystem. Frameworks such as Apache Camel or Spring Integration offer a wealth of components that facilitate connections to a variety of services and data sources. Node.js is favored for constructing lightweight and efficient integration services, particularly effective when dealing with JSON APIs and real-time data streams. It can utilize libraries like Express.js to create API endpoints and Axios for executing HTTP requests. Python is valued for its simplicity and readability, which makes it an excellent option for scripting and automation tasks within the integration layer. It can employ libraries such as Requests, which simplifies HTTP calls, and Pandas, which is powerful for data manipulation tasks.

The sixth layer is the User Interface 1201 Layer, which provides a user-friendly interface for investors to interact with the system. This may include web or mobile applications that allow users to buy, sell, or manage their tokenized assets. The user interface 1101 layer is designed to be intuitive and accessible, simplifying the process of participating in the digital asset market.

The User Interface 1101 Layer may utilize a multi-tiered software architecture to provide a seamless and intuitive user 1001 experience for interacting with the system. This architecture may include a front-end client, a back-end server, and an application programming interface (API) layer.

The front-end client may be developed using modern web technologies such as HTML5, CSS3, and JavaScript frameworks like React.js or Angular.js, which offer responsive design and dynamic user 1001 interfaces. For mobile applications, native development using Swift for iOS and Kotlin for Android, or cross-platform solutions like Flutter or React Native, may be employed.

The back-end server may be built using server-side languages such as Node.js, Python, or Ruby on Rails. It may handle business logic, user 1001 authentication, and communication with the blockchain network 101 and other system components.

The API layer may serve as the intermediary between the front-end and back-end, facilitating data exchange and operations requests. RESTful APIs or GraphQL may be used to standardize the communication protocols, ensuring consistency and ease of integration.

The programming details for the User Interface 1101 Layer may involve the use of version control systems like Git for collaborative development and maintaining code integrity. Continuous integration/continuous deployment (CI/CD) pipelines may be set up using tools like Jenkins or GitHub Actions to automate the testing and deployment processes.

Security considerations are paramount and could include HTTPS for secure data transmission, OAuth for authorization, and JSON Web Tokens (JWT) for secure authentication.

In some embodiments, the system may also include a Decentralized Finance (DeFi) Layer, which enables advanced financial operations such as lending, borrowing, and yield farming with the tokenized assets. This layer leverages the programmability of smart contracts to create complex financial products and services on the blockchain.

Centralized aspects of the system may include the Securities Exchange Integration and Custodian Services Integration. These components involve traditional financial institutions and services that operate in a centralized manner. For example, the integration with securities exchanges or alternative trading systems (ATS) that support the trading of tokenized stocks provideing access to established market infrastructure and liquidity. Similarly, custodian services offer secure storage and management of digital assets, which are typically centralized operations that ensure the safekeeping of assets on behalf of the users. The Compliance Verification Layer also has centralized characteristics, as it may use centralized databases and regulatory lists to perform compliance checks 1005 and monitor transactions for illegal activities. This layer ensures that all trades adhere to KYC, AML, and other regulatory requirements, which are typically enforced by centralized authorities.

Decentralized aspects of the system can include Decentralized Securities Trading Platforms, Peer-to-Peer (P2P) Matching, and Cross-Chain Swaps. Decentralized platforms for trading tokenized securities operate on blockchain technology and enable peer-to-peer trading without the intermediation of traditional brokers. This reduces costs and increases transparency, as the trades are executed directly between users on the blockchain. P2P matching facilitates direct trades between users within the platform, leveraging the decentralized nature of blockchain to reduce fees and enhance privacy. Cross-chain swaps allow users to trade assets across different blockchain networks without the involvement of a centralized intermediary, utilizing atomic swaps or other interoperability protocols.

The Asset Tokenization Layer and Smart Contract Layer are inherently decentralized, as they rely on blockchain technology to create and manage digital representations of real-world assets. Smart contracts govern the issuance, transfer, and management of these tokens, operating in a decentralized manner on the blockchain network 101. The Decentralized Finance (DeFi) Layer represents another decentralized aspect of the system, enabling advanced financial operations such as lending, borrowing, and yield farming with tokenized assets. This layer uses the programmability of smart contracts to create complex financial products and services that operate in a decentralized ecosystem.

The Decentralized Finance (DeFi) Layer utilizes various software technologies to enable advanced financial operations with tokenized assets on a blockchain platform. This layer leverages the programmability and automation capabilities of smart contracts to facilitate complex financial transactions such as lending, borrowing, and yield farming in a decentralized manner.

The software architecture of the DeFi Layer may include components such as DeFi protocols, liquidity pools, and automated market makers (AMMs) that enable users to engage in financial activities without the intermediation of traditional financial institutions. The DeFi Layer is a complex and innovative aspect of blockchain technology, encompassing a variety of services and operations that are governed by smart contracts. These smart contracts, known as DeFi Protocols, set the rules for decentralized finance (DeFi) services. They cover a range of functionalities, including lending protocols that allow users to borrow and lend assets, decentralized exchanges (DEXs) that enable the trading of cryptocurrencies without a central authority, and yield optimization platforms that aim to maximize returns on crypto assets.

Another integral component of the DeFi Layer is Liquidity Pools. These are reserves of tokens that are held within a smart contract and provide the liquidity that is requisite for trading pairs on DEXs or for lending services. Users who contribute their tokens to these pools can earn rewards in the form of transaction fees or interest, incentivizing the provision of liquidity to the ecosystem.

Automated Market Makers (AMMs) represent a shift in asset trading on DEXs. Unlike traditional exchanges that rely on order books to determine asset pricing, AMMs use algorithms to price assets and provide liquidity. This approach allows for the automatic and permissionless exchange of tokens.

The development of smart contracts for DeFi protocols typically involves using Solidity to write the code that will be deployed on the blockchain. These contracts are equipped with functions that manage the depositing of assets, the execution of trades, and the calculation of yields.

Interoperability is a feature that is increasingly being integrated into the DeFi Layer. It allows for DeFi operations to extend across different blockchain networks. This cross-chain functionality can be achieved through the use of blockchain bridges or other interoperability protocols that facilitate communication and transaction between disparate blockchain systems.

The present invention can be used to enhance the liquidity, efficiency, and accessibility it provides to asset trading. By tokenizing assets, the system enables fractional ownership, where investors can purchase and own a portion of an asset, making investment opportunities more accessible to a broader range of investors. Additionally, the blockchain infrastructure reduces the reliance on intermediaries, streamlining the trading process and reducing transaction costs and times.

The system ensures that all transactions recorded on the blockchain are in compliance with the relevant securities laws and regulations.

In some aspects, the system may verify the registration status of the recipient or the signer with the platform during the process of transferring an ERC-20 standard digital asset. This verification process 112 may be an integral part of the modified transfer function 111 embedded in the ERC-20 standard smart contract. The function may be programmed to automatically check the registration status of the recipient or the signer whenever a transfer of the digital asset is initiated.

In some embodiments, the verification process 112 may involve checking a registry of registered users or wallets maintained by the registration module 102 of the system. The registry may include information such as the wallet addresses of the registered users, their registration status, and any other relevant information. If the recipient or the signer is found in the registry and their registration status is verified, the modified transfer function 111 may proceed with the transfer of the digital asset.

In other cases, the verification process 112 may involve checking a separate set of contracts that may implement ERC-721 and ERC-1155 standards representing the identity of the recipient or the signer. The ERC-721 contract, a standard for non-fungible tokens on the blockchain, and the ERC-1155 contract, a standard for representing multiple fungible and non-fungible tokens in a single contract on the blockchain may be used to represent the identity of the recipient or the signer in a secure and verifiable manner. The modified transfer function 111 may interact with the identity contracts to verify the registration status of the recipient or the signer.

In some aspects, the system may verify the registration status of the recipient or the signer by examining a separate set of contracts that may implement the ERC-721 and ERC-1155 standards representing their identity. This process involves several steps and methods to ensure secure and accurate verification.

The ERC-721 contract, known for its ability to create non-fungible tokens (NFTs), may be utilized to represent a distinct digital identity for each registered user 1001 or wallet. When a user 1001 registers with the platform, a distinct ERC-721 token may be minted and assigned to their address. This token serves as a cryptographic representation of their verified identity and registration status.

During a transaction, the modified transfer function 111 within the ERC-20 smart contract 113 may initiate a call to the ERC-721 contract associated with the recipient's or signer's address. This call may invoke a specific function within the ERC-721 contract designed to verify the registration status.

The verification function within the ERC-721 contract can perform several checks to ensure the validity and authenticity of the user's registration status. First, it can verify the existence of a token for the given address, as the absence of a token would indicate that the address is not registered with the platform. Next, the function can check the token's validity by examining a timestamp or status flag to ensure it has not expired or been revoked. The ERC-721 token can also contain additional attributes or metadata related to the user's registration status, which the verification function may examine to confirm specific details such as the level of KYC verification completed or any restrictions on the account. Lastly, the function can verify that the address initiating the transaction is indeed the owner of the ERC-721 token, preventing impersonation attempts.

The ERC-721 contract may also implement access control mechanisms to ensure that authorized contracts or addresses (such as the platform's ERC-20 contract) can query the registration status. This may be achieved through the use of modifiers or separate permissioning functions within the ERC-721 contract.

Upon completing these checks, the ERC-721 contract may return a boolean value or a more complex data structure to the calling ERC-20 contract, indicating whether the registration is valid and including any relevant details about the registration status.

The system may employ caching mechanisms to store the results of recent verifications, reducing the number of on-chain calls and improving performance. However, the cache may be designed with a short expiration time to ensure that up-to-date registration information is used for each transaction.

In some embodiments, the system may utilize a merkle tree or similar data structure to efficiently prove the inclusion of a user's registration status to store all registration data on-chain. The root of this merkle tree may be periodically updated in the ERC-721 contract, allowing for efficient verification of registration status.

The verification process 112 may also include checks against a revocation list stored in the ERC-721 contract. This list could contain addresses whose registration has been revoked due to violations of platform rules or regulatory requirements.

In yet other aspects, the verification process 112 may be designed to be adaptable and flexible, allowing for updates or modifications as per changing regulations or requirements. For instance, the system may update the registry of registered users or wallets as new users register or existing users update their registration information. In terms of Blockchain Standards, the system, which currently relies on the ERC-20 standard, could be adapted to incorporate other smart contract standards such as ERC-1155. This particular standard allows for the creation of both fungible and non-fungible tokens within the same contract, potentially expanding the types of financial assets the system can manage.

The methods of Compliance Enforcement within the system could also see variations. While the current approach involves modifying the ERC-20 standard's transfer function, alternative strategies could be employed. One such strategy could involve the use of a dedicated smart contract to oversee and enforce compliance, which would be linked to the main asset contract and activated with each transfer initiation.

In some aspects, the system may employ a variety of algorithms and methods to detect wash trading, wash sales, and tax avoidance. The system in question is equipped with a suite of algorithms and methods designed to identify and prevent various forms of market manipulation and tax evasion, such as wash trading, wash sales, and tax avoidance. Algorithms that could be utilized include pattern recognition algorithms, volume analysis, price correlation analysis, time series analysis, relationship mapping, anomaly detection, smart contract analysis, transaction graph analysis, tax reporting analysis, cross-platform analysis, and historical data analysis.

The detection module 103 is further configured to identify and prevent tax avoidance through a series of sophisticated algorithms and data analysis techniques. This functionality complements its ability to detect wash trading, providing a comprehensive approach to maintaining the integrity of financial transactions on the blockchain.

In some aspects, the detection module 103 may employ pattern recognition algorithms to identify transaction sequences that are indicative of tax avoidance strategies. These algorithms may analyze the timing, frequency, and value of transactions to detect patterns that align with known tax avoidance schemes. For instance, the module may flag a series of transactions that appear to artificially realize losses near the end of a tax year, followed by repurchases shortly after the new tax year begins.

The detection module 103 may also utilize machine learning models trained on historical data of confirmed tax avoidance cases. These models can be continuously updated to adapt to new and evolving tax avoidance techniques. The machine learning algorithms may consider various factors such as transaction volumes, asset holding periods, and the jurisdictions involved in the transactions to identify potential tax avoidance activities.

In some embodiments, the detection module 103 may incorporate a rules-based engine that applies predefined criteria to identify transactions that may be structured to avoid tax obligations. This engine may include rules based on tax laws from various jurisdictions, allowing the system to flag transactions that appear to exploit loopholes or gray areas in tax regulations.

The module may also employ network analysis techniques to identify clusters of wallets or accounts that may be working in concert to avoid taxes. By mapping the relationships between different wallets and their transaction patterns, the system can detect complex tax avoidance schemes that involve multiple parties or accounts.

Additionally, the detection module 103 may integrate with external data sources, such as public company financial reports or tax authority databases, to cross-reference transaction data with reported financial information. This integration allows the system to identify discrepancies that may indicate attempts to underreport taxable events or misrepresent the nature of transactions for tax purposes.

In some aspects, the detection module 103 may utilize temporal analysis to identify sudden changes in transaction patterns or asset holdings that coincide with tax reporting deadlines or changes in tax laws. This analysis can help detect attempts to time transactions in a way that minimizes tax liability.

The system may also employ anomaly detection algorithms to identify transactions or patterns that deviate from the user's historical behavior or from typical patterns observed across the platform. These anomalies may be flagged for further investigation as potential indicators of tax avoidance strategies.

When potential tax avoidance activities are detected, the system may trigger a series of actions. These may include temporarily freezing the associated accounts, flagging the transactions for review by compliance officers, or generating detailed reports for submission to relevant tax authorities.

The detection module 103 may also work in conjunction with the geographical restriction module 116 to ensure that transactions comply with the tax laws of the jurisdictions involved. This collaboration helps prevent the use of cross-border transactions as a means of tax avoidance.

In some embodiments, Pattern Recognition Algorithms, volume analysis, price correlation analysis, time series analysis, relationship mapping, anomaly detection, smart contract analysis, tax reporting analysis, and/or historical analysis could be utilized to detect wash trading, wash sales, and tax avoidance.

A computer readable medium could utilize a variety of data types and sources to perform computations to detect and prevent financial malpractices such as wash trading, wash sales, and tax avoidance. These data types and/or sources could include transaction data, timestamps, transaction amounts, the types of assets traded, and the wallet addresses involved, wallet information, creation dates of blockchain wallets, the transactions associated with them, and their historical balances, smart contract Interaction data, values of parameters passed, state changes on the blockchain, exchange trading logs from cryptocurrency exchanges, historical and real-time trading data, order book details, and records of trades, as well as withdrawal and deposit activities. Regulatory Compliance Lists could include information on sanctioned entities, politically exposed persons (PEPs), and individuals known for fraudulent activities, personal identification information for KYC and AML checks verified against official government databases, public records, court filings, property records, corporate registries, social media and online forums with publicly available data where users might discuss their trading activities and strategies, Open Source Intelligence (OSINT), financial news, real-time and historical market data, news feeds, and financial reports, and/or tax reporting data.

The computer system could utilize behavior analytics focused on user patterns and behavior to establish baselines and detect anomalies that may indicate illicit activities. Risk Assessment Databases would then further categorize entities based on their risk profiles, aiding in the prioritization of monitoring and investigation efforts.

In some embodiments, the technical architecture of the system may include integration with various third party data sources to support the detection module's ability to identify and block illegal activities such as wash trading and tax avoidance. The integration of these data sources with the system's software may involve the use of application programming interfaces (APIs) that allow for the seamless exchange of data between the system and external databases. APIs may be used to query these databases for relevant information, such as transaction histories, wallet information, and regulatory compliance lists, which can then be fed into the detection module 103 for analysis.

In some cases, the system may employ middleware that acts as an intermediary layer between the blockchain network 101 and the external data sources. This middleware may be responsible for transforming the data into a format that is compatible with the system's software, as well as for managing the flow of data to ensure that the detection module 103 receives timely and accurate information.

The middleware layer in the system serves as a bridge between the blockchain network 101 and external data sources, facilitating the exchange and processing of data for the modified ERC-20 contract and its associated transfer function. In some aspects, the middleware may consist of several components, each designed to handle specific tasks within the data processing pipeline.

One component of the middleware may be a data transformation service, which is responsible for converting data from external sources into a format that is compatible with the system's software. This service may employ data mapping techniques to align the structure of external data with the expected input format of the detection module 103. For example, it may convert JSON objects retrieved from an API into smart contract-readable formats such as byte arrays or Ethereum-specific data types.

Another component of the middleware may be a data routing service, which ensures that data flows efficiently between the external sources and the system's internal components. This service may utilize message queuing protocols to manage the prioritization and delivery of data packets. It may also implement load balancing mechanisms to distribute processing loads across multiple nodes, preventing bottlenecks and ensuring high availability of the system.

The middleware may also include an event handling service, which listens for specific events emitted by the blockchain network 101, such as the initiation of a transfer request or the detection of suspicious trading patterns. Upon detecting an event, this service may trigger predefined workflows within the system, such as invoking the modified transfer function 111 or alerting the detection module 103 to perform further analysis.

The software architecture of the modified ERC-20 contract may be designed to accommodate the additional compliance checks 1005 introduced by the system. The modified transfer function 111 within the contract may be extended to include calls to the middleware services. For instance, before executing a transfer, the function may query the data transformation service to retrieve the registration status of the recipient or signer from the external KYC/AML databases.

The modified transfer function 111 may also incorporate logic to interact with the detection module 103. It may pass transaction details to the detection module 103 for analysis, and based on the results, it may proceed with the transfer or revert the transaction. This logic may be implemented using smart contract programming patterns such as modifiers, which can enforce preconditions for function execution.

In some cases, the modified ERC-20 contract may be structured to include proxy contracts or delegatecall operations, allowing for the dynamic updating of the transfer function logic without redeploying the whole contract. This feature may be particularly useful for adapting to changes in regulatory requirements or upgrading the system's compliance mechanisms.

The system's software may include specialized algorithms and machine learning models that are designed to process and analyze the data obtained from these sources. These algorithms may be capable of identifying complex patterns and relationships within the data that may not be readily apparent, thereby enhancing the system's ability to detect wash trading and tax avoidance.

In some aspects, the system may employ various types of algorithms to enhance the detection of illegal activities 209 such as wash trading and tax avoidance. These algorithms may include, but are not limited to, statistical algorithms, pattern recognition algorithms, anomaly detection algorithms, and machine learning algorithms such as supervised learning, unsupervised learning, reinforcement learning, neural networks, decision trees, support vector machines, and clustering algorithms.

The computer readable medium could utilize data types and sources such as volume and frequency analysis, trade pair correlation, account linkage analysis, order book analysis, profit and loss analysis, and round-trip trading detection are methods that can be used to identify suspicious trading patterns, such as wash trading. These methods analyze trade data for unusual activity, like high-frequency trades, self-matching orders, and unprofitable transactions, which may indicate market manipulation.

Specific algorithms utilized to detect market manipulation could include linear regression and ANOVA, Z-score and one-class SVM, decision trees, neural networks, supervised learning algorithms, unsupervised learning algorithms, forcement learning algorithms, CNNs and RNNs, decision trees, SVMs, DBSCAN or OPTICS.

The system's algorithms can be executed by central processing unit (CPU) and memory components, for data processing. In some embodiments, the CPU's Arithmetic Logic Unit (ALU) is responsible for carrying out the arithmetic operations that are foundational to statistical algorithms, such as linear regression and hypothesis testing. These algorithms, implemented using a computer, can analyze financial data and patterns that may indicate market manipulation or other forms of financial malfeasance.

In some embodiments, variables and coefficients involved in these calculations are temporarily stored in the CPU's registers, allowing for swift access and manipulation by the ALU. Once the statistical analyses are complete, the results are stored in the Random Access Memory (RAM) for subsequent use or for comparison against threshold values, a process overseen by the CPU's Control Unit (CU). The pattern data and intermediate results are stored in the L1 and L2 cache, ensuring rapid retrieval during iterative processing, which is particularly beneficial when the system is analyzing sequence alignment and template matching. These algorithms may utilize RAM to store historical data, providing a benchmark against which current transactions are compared to detect anomalies. The trained models can be stored in RAM or hard drives, and the L3 cache may be used to store model parameters that are frequently accessed by multiple CPU cores during prediction or classification tasks. The trained models may also be cached in L2 or L3 cache for quick access during execution.

The CPU, with its ALU and CU, is the primary executor of the algorithms, performing calculations and controlling the flow of data. The system's memory, including RAM and cache, provides storage for data, models, and intermediate results, ensuring that the algorithms have quick access to the information they require to function effectively. The use of the word “the” is simply illustrative and does not constitute the a specific CPU unit or components. Further, other CPU, memory, or hardware components could be utilized to execute these algorithms and/or software, including hardware accelerators or specific application specific integrated circuits (ASICs). Virtualized hardware and/or cloud computing could also be utilized.

The system may also utilize different computer architectures to support the processing and execution of these algorithms. Such architectures may include, but are not limited to, distributed computing architectures, cloud computing architectures, parallel processing architectures, and traditional single-processor architectures. Additionally, specialized hardware such as graphics processing units (GPUs), tensor processing units (TPUs), and field-programmable gate arrays (FPGAs) may be employed to accelerate the processing of complex algorithms and machine learning models. In some embodiments, a blockchain interface hardware module can be custom-designed hardware to interact with various non-EVM and EVM compliant blockchains. The user interface 1101 and interaction component is web-based, built using secure web frameworks, and designed to be responsive across a range of devices, including desktops, tablets, and smartphones. It includes high-speed API endpoints for real-time data ingestion and querying of blockchain states, along with caching mechanisms to facilitate quick retrieval of frequently accessed data. It incorporates multi-factor authentication (MFA) and role-based access control (RBAC) to ensure secure user 1001 management. These MFA and RBAC tokens and encryption keys, including private keys for blockchain wallet authentication, can be hardware and/or software based.

Security hardware such as Hardware Security Modules (HSMs) and Trusted Platform Modules (TPMs) are integral for secure cryptographic operations and hardware-based integrity checks. The software and firmware include custom firmware for hardware initialization, hypervisors for virtualization, and blockchain-specific middleware for transaction validation and smart contract execution.

In some aspects, the system may also include a data storage component, such as a database 1106 or a distributed ledger, where information from the external data sources can be stored and indexed for efficient retrieval and analysis. In some embodiments, this database 1106 could be immutable, providing cryptographically verifiable transaction logs. This data storage component may be designed to handle large volumes of data and to support high-performance queries by the detection module 103.

In some embodiments, the system may incorporate a data storage component that leverages cloud computing services to manage and store information from external data sources. This cloud-based data storage component may utilize scalable storage solutions to handle the large volumes of data generated by the blockchain network 101 and associated transactions.

The data storage component may be designed to index the stored information, facilitating efficient retrieval and analysis. Indexing may be achieved through database 1106 services which provide capabilities for sorting, filtering, and searching the data based on various attributes. These services may be optimized for high-performance queries, enabling the detection module 103 to rapidly access and analyze data to identify and block illegal activities such as wash trading and tax avoidance.

Additionally, the system may incorporate data analytics services to perform complex data analysis on the stored information. These services can process and transform large datasets, enabling the detection module 103 to apply sophisticated algorithms and machine learning models to the data for enhanced detection of illicit activities.

In some embodiments, the system can incorporate a data storage component that utilizes cloud computing services to manage and store information from external data sources. This cloud-based data storage component utilizes scalable storage solutions to handle the large volumes of data generated by the blockchain network 101 and associated transactions.

Furthermore, the system's software may include a reporting and alerting mechanism that can notify system administrators or regulatory authorities when potential illegal activities are detected. This mechanism may generate reports that summarize the findings of the detection module 103 and provide detailed evidence of the suspected illicit activities.

The technical architecture of the system is designed to facilitate the integration of external data sources with the system's software, enabling the detection module 103 to effectively identify and block illegal activities in the trading of financial assets on the blockchain.

Monero and ZCash are privacy-focused cryptocurrencies that employ advanced cryptographic techniques to enhance transaction privacy and anonymity. Monero uses ring signatures and stealth addresses as part of its privacy protocol. Ring signatures mix the user's account keys with public keys obtained from Monero's blockchain to create a ‘ring’ of possible signers, making it cryptographically challenging to identify the actual signer of a transaction. Stealth addresses are one-time addresses, generated for each transaction on behalf of the recipient, to ensure that the true destination of the transaction is not linked to the recipient's wallet on the blockchain.

ZCash, on the other hand, uses zk-SNARKs (Zero-Knowledge Succinct Non-Interactive Arguments of Knowledge) to enable private transactions. zk-SNARKs allow a transaction to be verified without revealing sender, receiver, or transaction amount. ZCash's implementation of zk-SNARKs requires complex cryptographic computations. For instance, blockchains that implement ZKP-friendly cryptographic primitives, such as BLS12-381 curves used in zk-SNARKs, could interact with ZCash. These include blockchains like Zilliqa, which has implemented zk-SNARKs to enable private transactions, and Tezos, which has proposed adding zk-SNARKs capabilities.

In the present invention, smart contracts on these blockchains could be designed to interact with ZCash by verifying ZKP without revealing the underlying transaction data. This would allow the smart contracts to enforce compliance rules, such as checking against sanction lists or confirming transaction legitimacy, without breaching the privacy of the users. For Monero, which uses ring signatures and stealth addresses, blockchains that support similar cryptographic schemes or have the capability to verify such schemes could interact with it. For example, a blockchain implementing CryptoNote, a protocol that forms the basis of Monero's privacy features, could potentially interact with Monero's network.

In the present invention, the blockchain can implement cryptographic libraries that support the same or similar cryptographic algorithms as Monero. This could include the CryptoNight proof-of-work algorithm, which Monero uses for mining and transaction verification. The blockchain would also have to support the range proofs that Monero uses to verify that transaction outputs are valid without revealing their amounts.

The blockchain in the present disclosure would have protocols or mechanisms that enable secure and private cross-chain communication. This could be achieved through various interoperability solutions, including atomic swaps and hashed time-locked contracts, which would allow for seamless and secure transactions between different blockchain networks. For scalability, solutions such as layer-2 scaling, sharding, or other innovative scalability enhancements could be used.

A blockchain designed to work with privacy-centric cryptocurrencies such as Monero and ZCash can be executed using a computer system that comprises central processing unit (CPU) and memory components. These components are responsible for the demanding cryptographic computations and data management that these privacy protocols require.

The CPU's Arithmetic Logic Unit (ALU) can perform the cryptographic calculations that make up the core of Monero's ring signatures and ZCash's zk-SNARKs. For Monero, the ALU handles the complex task of blending a user's account keys with public keys from the blockchain, creating a group of potential signers that conceals the actual signer's identity. When it comes to ZCash, the ALU is tasked with generating and verifying zero-knowledge proofs, which are proofs that confirm the validity of a transaction and verify user registration without revealing any specific details about it.

The Control Unit (CU) within the CPU directs the sequence of tasks by retrieving, decoding, and executing the instructions that allow the blockchain to interact with Monero and ZCash. It oversees the execution of smart contracts that carry out compliance checks 1005, ensuring that these checks are done without violating the privacy of the transactions.

Registers, which are small and fast storage areas within the CPU, can serve as temporary holding spots for the data and instructions that are in active use. They can be storage depots for the cryptographic keys, hashes, and other data that provide generation and verification of ring signatures and zk-SNARKs.

The system's memory components also are used. Random Access Memory (RAM) is the primary storage space for transaction data, smart contract code, and the intermediate results of cryptographic operations. It provides a workspace for the CPU to efficiently access and manipulate data related to transactions involving privacy coins. Additionally, RAM maintains the blockchain's ledger state, can include the Unspent Transaction Output (UTO) set for Monero and the encrypted transaction details for ZCash.

Cache memory, comprising L1, L2, and L3 caches, serves as a temporary repository for data that the CPU frequently accesses. The L1 cache, being the fastest and closest to the CPU cores, can hold the active cryptographic keys and the instructions that are in high demand for privacy protocols. The larger but slower L2 and L3 caches store additional cryptographic data and smart contract state information that may not be accessed as frequently but still require expedient access.

Non-volatile memory, such as Solid-State Drives (SSDs), is employed to permanently store the blockchain's historical data. This includes past transactions and the state of smart contracts, ensuring that data remains intact even when the system is powered down, thus providing a lasting record of all interactions with Monero and ZCash.

The blockchain's interaction with privacy coins can be further enhanced by specialized hardware components. Graphics Processing Units (GPUs) can be leveraged to parallelize the processing of cryptographic algorithms, particularly those involved in the computation of zk-SNARKs, which are inherently parallelizable due to their mathematical structure. GPUs expedite the generation and verification of zero-knowledge proofs by handling multiple operations concurrently.

Field-Programmable Gate Arrays (FPGAs) and Application-Specific Integrated Circuits (ASICs) can be utilized to perform specific optimized cryptographic tasks. These components can be programmed or custom-built to enhance the performance of tasks such as hashing or digital signature verification. By executing repetitive and computationally demanding tasks more efficiently than general-purpose CPUs, they provide a performance boost for the blockchain's interactions with privacy coins.

In some aspects, the present system may be implemented on a cross-chain blockchain architecture that allows for compatibility with any blockchain protocol, thereby extending the system's reach beyond EVM compatible and Turing complete blockchains. This cross-chain functionality is achieved through the use of interoperability protocols that enable communication and transaction execution across diverse blockchain networks.

The cross-chain blockchain architecture may include a set of interoperability protocols such as blockchain bridges, sidechains, or other cross-chain communication mechanisms. These protocols facilitate the transfer of assets and information between different blockchain networks, allowing the system to enforce compliance across a broader range of blockchain ecosystems.

For example, the system may utilize blockchain bridges to connect with blockchains that have different consensus mechanisms or smart contract functionalities. A blockchain bridge can act as a link between the system's native blockchain and an external blockchain, enabling the transfer of digital assets in a secure and verifiable manner. This bridge may employ smart contracts on both sides of the connection to ensure that the assets are locked on one blockchain and corresponding assets are released on the other blockchain, maintaining the integrity of the asset transfer process.

In some cases, the system may use sidechains to extend its functionality to blockchains that are not natively compatible with the ERC-20 standard. A sidechain is a separate blockchain that runs in parallel to the main blockchain and is connected to it via a two-way peg. The system can leverage sidechains to create a compliant environment for financial asset 1007 trading, where the sidechain operates under the system's compliance rules while allowing assets to move between the main blockchain and the sidechain.

The cross-chain blockchain architecture may also include a decentralized oracle network that provides the system with access to external data sources and services. Oracles are third-party services that feed data from outside the blockchain to smart contracts within the blockchain. By integrating with a decentralized oracle network, the system can obtain real-time information about asset prices, regulatory updates, and other relevant data that is instrumental in enforcing compliance.

Technical details of the cross-chain blockchain architecture may include the use of specialized protocols and algorithms that enable the secure and efficient transfer of assets and information across blockchain networks. These protocols may involve cryptographic techniques such as hash locking and time-locking to ensure that transactions are atomic, meaning they either complete fully or not at all, preventing the risk of one party defaulting on the transaction.

Mathematically, the architecture may rely on complex algorithms that can handle the conversion and mapping of different cryptographic standards and token representations. For example, the architecture may use mathematical models to calculate exchange rates between different assets or to verify the equivalence of assets across chains.

From a programming perspective, the architecture may be implemented using a combination of smart contracts and off-chain components. Smart contracts, written in languages such as Solidity or Vyper, may be deployed on multiple blockchains to handle the on-chain logic of asset transfers. Off-chain components, possibly written in languages like Go, Rust, or Node.js, may manage the communication between different blockchains and coordinate the transfer process.

The software and computer architecture of the cross-chain blockchain system may include distributed ledger technologies, consensus mechanisms, and peer-to-peer networking. The system may employ distributed databases to store cross-chain transaction data and state information. Consensus mechanisms may be adapted to validate and record cross-chain transactions, ensuring consistency and finality across the involved networks.

Additionally, the architecture may utilize containerization and microservices to modularize different functionalities, such as transaction processing, data validation, and compliance checking. This modular approach can enhance the scalability and maintainability of the system.

To ensure privacy and security in cross-chain transactions, the architecture may integrate zero-knowledge proofs, allowing the system to verify the compliance of transactions without revealing sensitive information. These proofs may be generated and verified using cryptographic libraries that support algorithms like zk-SNARKs or zk-STARKs.

In some aspects, the present system may utilize homomorphic encryption as an advanced cryptographic technique for smart contract creation. Homomorphic encryption allows for computations to be performed on encrypted data without needing to decrypt it first. This property is particularly useful for maintaining privacy and security in smart contracts that handle sensitive data. For example, a smart contract could perform operations on encrypted financial data, such as aggregating encrypted balances or verifying encrypted transactions, without exposing the underlying data.

Secure multi-party computation (SMPC) is an advanced cryptographic technique that a computer system can implement to enable multiple parties to collaboratively compute a function over their private inputs while maintaining the privacy of those inputs. When applied to smart contracts, SMPC allows for the verification of contract conditions without exposing the private data of the involved parties.

The process begins with the computer system initiating the SMPC protocol, establishing secure communication channels, and generating cryptographic keys for data encryption and sharing. Each party then encrypts their private inputs using these keys, ensuring that the data remains confidential throughout the computation.

Next, the computer system distributes the encrypted inputs to all participating parties'computers. The SMPC protocol breaks down the computation into segments that can be processed in parallel, keeping the underlying data hidden.

The computers then perform secure computations on the encrypted data, employing cryptographic methods like homomorphic encryption, which enables operations on encrypted data to yield encrypted results. When decrypted, these results correspond to the outcomes of operations on the original data.

Once each computer has completed its part of the computation, the partial results are aggregated. The SMPC protocol is designed to combine these results without disclosing any private inputs.

The smart contract uses the aggregated result to verify whether the transaction meets the set compliance criteria. If the conditions are satisfied, the transaction is executed; otherwise, it is rejected. Throughout this process, the confidentiality of each party's inputs is preserved.

Finally, the computer system performs a cleanup, securely erasing any temporary data and cryptographic materials to prevent any potential data breaches.

This implementation of SMPC in smart contracts by a computer system ensures that complex contractual conditions can be verified without compromising the privacy of transaction data, leveraging advanced cryptographic algorithms and secure communication protocols to protect the parties'inputs.

Additionally, the computer system may incorporate cryptographic commitments, which allow one party to commit to a value while keeping it hidden until a later time, with the ability to reveal the value later and verify that it has not changed. This technique can be used in smart contracts to ensure that parties to a contract cannot change their inputs after the fact. For example, a smart contract could use cryptographic commitments to lock in the terms of a financial trade, which can then be revealed and verified at the time of settlement.

The use of threshold signatures could also be integrated into the system's smart contract architecture. Threshold signatures are a form of digital signature that requires a subset of a group of users to sign a transaction before it can be executed. This can enhance the security of smart contracts by distributing the control over contract execution among multiple parties, reducing the risk of single points of failure or malicious control.

In some embodiments, the system may incorporate the use of zero-knowledge proofs (ZKPs) to facilitate compliance enforcement for transactions involving privacy coins such as Monero or ZCash. ZKPs are cryptographic methods that enable one party to prove to another party that a statement is true without revealing any information beyond the validity of the statement itself. This characteristic of ZKPs is particularly advantageous for privacy coins that prioritize anonymity and privacy.

In some embodiments, zero-knowledge proofs (ZKPs) can be utilized as a component of the blockchain compliance systems. These protocols can confirm the validity of a transaction's attributes without exposing any confidential information that users prefer to keep hidden.

Interactive proof systems can be used for identity verification or credential authentication. In one scenario, a user 1001 is able to affirm their identity to the system without disclosing any personal identity information. The system presents a challenge to the user 1001, who in turn provides a response that substantiates their possession of the correct identity credentials. This feature is particularly beneficial for systems that mandate users to prove their authorization to execute a transaction without unveiling their complete identity details.

Non-Interactive Zero-Knowledge Proofs (NIZKPs) can also be used in the blockchain compliance systems due to their ability to function without the prover and verifier needing to interact. This attribute allows for compliance verifications to be conducted autonomously by the blockchain network 101. By applying the Fiat-Shamir heuristic, a user 1001 can demonstrate adherence to regulatory rules—such as holding a valid trading license for a specific asset—without having to reveal the license itself. The blockchain can authenticate this proof independently, thereby streamlining the compliance process.

Zero-Knowledge Succinct Non-Interactive Arguments of Knowledge (zk-SNARKs) can validate transactions with a compact proof size, which is particularly advantageous for blockchain systems where efficiency is of the essence. For instance, a user 1001 can validate that they possess sufficient funds for a transaction without disclosing their total account balance. The compliance system verifies the proof to confirm that the transaction is in line with financial regulations, such as anti-money laundering laws, without the system having to access the user's balance or transaction history.

Zero-Knowledge Scalable Transparent Arguments of Knowledge (zk-STARKs) are another variant of ZKPs that do not necessitate a trusted setup, making them ideal for verifying transaction compliance without revealing sensitive data. A user 1001 could, for example, verify that a transaction amount is within a legal range without disclosing the specific amount. This capability is especially pertinent for privacy coins, which conceal transaction amounts, yet still require users to abide by regulatory norms.

Bulletproofs can be employed for efficient range proofs within a compliance system. They enable the proof that a transaction value lies within a designated range without revealing the actual value, thus ensuring that transactions are neither too large nor too small as per regulatory requirements. The compact nature of these proofs is beneficial for blockchains where conserving space is a priority.

Sigma protocols are leveraged in a blockchain compliance system to validate the knowledge of a discrete logarithm, such as a private spending key, without exposing the actual value. This allows for the verification of a user's authority to spend a particular asset without divulging the asset's specifics, thereby ensuring compliance with ownership and transfer regulations.

In the context of the present system, a cross-chain smart contract that interacts with Monero could be designed to facilitate compliance enforcement while respecting the privacy features of Monero transactions. In a potential actual implementation of the system that interacts with the Monero blockchain, the system would require a way to verify transactions while preserving the privacy and anonymity features of Monero. Since Monero transactions are private by default, utilizing zero-knowledge proofs (ZKPs) could be a suitable approach. In some embodiments, the system could implement a smart contract on the Ethereum blockchain 1104 that interacts with a trusted oracle or a set of oracles that have the ability to generate and verify ZKPs related to Monero transactions.

The actual generation and verification of ZKPs could be handled off-chain by the oracle, which would use cryptographic libraries that support the generation of ZKPs for Monero's ring signatures and stealth addresses. The oracle would then provide a ZKP to the smart contract, which verifies the proof on-chain without revealing any sensitive information about the Monero transaction.

The implementation could utilize secure and privacy-preserving oracle design, possibly using secure hardware or a decentralized network of oracles to prevent single points of failure and ensure the integrity of the verification process 112.

An oracle in the context of blockchain technology may refer to a system or entity that provides external data to smart contracts on the blockchain. Since smart contracts cannot access data outside their network, oracles serve as a bridge between the blockchain and the outside world, enabling smart contracts to execute based on real-world events and data. Oracles can be software-based, pulling data from online sources, or hardware-based, receiving input from the physical world.

A decentralized network of oracles is a system where multiple independent oracles work together to provide data to the blockchain. This decentralization can increase the reliability and security of the data provided, as it reduces the risk associated with relying on a single source of information. Decentralized oracles often use consensus mechanisms to agree on the data before it is sent to the smart contract, ensuring that the data is accurate and tamper-proof.

In some embodiments, the system may include a smart contract wallet 117 that is compatible with privacy-focused cryptocurrencies such as Monero or ZCash. This smart contract wallet 117 may be designed to facilitate transactions while maintaining the privacy and anonymity features inherent to these cryptocurrencies. The wallet may interact with the blockchain network 101 to execute transactions using privacy-preserving techniques such as ring signatures, stealth addresses, or zk-SNARKs.

The smart contract wallet 117 is designed to be accessible by both the user 1001 and the platform 119. This wallet is a secure digital storage mechanism that holds digital assets and is integrated into the blockchain network 101. A defining feature of this smart contract wallet 117 is the authorization granted to the platform to withdraw assets from third-party cryptocurrency exchanges either on behalf of the user 1001 or to restrict the user's access due to failures to comply with KYC/AML regulations.

The smart contract wallet 117 is structured to allow both the user 1001 and the platform to access and manage the assets contained within it. Users can interact with the wallet to perform transactions such as deposits, transfers, and withdrawals. The platform, on the other hand, has specific permissions that enable it to manage the assets in the wallet according to predefined rules and conditions set forth in the smart contract.

One of the permissions granted to the platform is the authority to initiate withdrawals of assets from third-party cryptocurrency exchanges. This authorization is encoded within the smart contract that governs the operation of the wallet. The smart contract includes functions that the platform can invoke to transfer assets from the exchange to the smart contract wallet 117.

The mechanism for authorizing the platform to withdraw assets is based on a set of cryptographic keys and permissions. The platform holds a set of keys or credentials that allow it to authenticate with the third-party exchange and request the withdrawal of assets. The exchange, recognizing the platform's authorization through the smart contract, processes the withdrawal request and transfers the assets to the smart contract wallet 117.

To ensure the security of transactions, smart contract wallet 117 incorporates multiple layers of protection. These measures include encryption of the wallet's contents, secure signing of transactions, and verification processes to confirm the legitimacy of withdrawal requests. The platform's withdrawal activities are logged and monitored to prevent unauthorized access or fraudulent transactions.

The smart contract wallet 117 can enforce compliance checks 1005 before executing a withdrawal, ensuring that the transaction adheres to anti-money laundering (AML) and Know Your Customer (KYC) regulations. The wallet can also be programmed to restrict withdrawals to or from jurisdictions where such transactions are prohibited by law.

The smart contract wallet 117 may be configured to hold a variety of digital assets, including those that adhere to privacy protocols. Users may deposit or withdraw assets from the wallet, and the wallet may be programmed to automatically handle the conversion between different types of assets. For example, a user 1001 may deposit Monero into the wallet and later withdraw an equivalent value in another cryptocurrency, with the wallet handling the privacy-preserving aspects of the transaction.

To ensure compliance with regulatory requirements, smart contract wallet 117 may incorporate mechanisms for verifying the identity of users. The wallet may also include features for reporting and record-keeping to assist with regulatory audits and compliance checks 1005.

In some cases, the smart contract wallet 117 may be integrated with a decentralized network of oracles to access external data sources for compliance verification. The oracles may provide the wallet with up-to-date regulatory information, exchange rates, or other relevant data.

In some embodiments, the smart contract wallet 117 is designed using a layered software architecture. At the top is the User Interface 1101 Layer, which serves as the point of interaction for users. It may feature graphical user 1001 interfaces (GUIs) or command-line interfaces (CLIs), enabling users to execute various operations such as transferring digital assets, reviewing their transaction history, and managing their registration with the platform. Beneath that lies the Business Logic Layer, which houses the core functions of the smart contract wallet 117. This includes the transaction processing logic, compliance enforcement, and interactions with the blockchain network 101. Typically, this layer is built using smart contracts written in a language like Solidity and then deployed onto the blockchain network 101.

The Data Access Layer is responsible for the storage and retrieval of data pertinent to the operations of the smart contract wallet 117. This layer interacts with the blockchain to obtain transaction data and may also utilize off-chain storage solutions for storing additional information, such as user 1001 registration details and data related to compliance. Next is the Blockchain Interaction Layer, which manages the communication between the smart contract wallet 117 and the blockchain network 101. Its functions include submitting transactions to the network, querying transaction statuses, and monitoring events that are emitted by smart contracts. The Security Layer is dedicated to safeguarding the smart contract wallet 117. It encompasses encryption of sensitive data, secure generation and storage of cryptographic keys, and user 1001 authentication mechanisms. Additionally, this layer focuses on smart contract security measures to mitigate vulnerabilities and protect against potential attacks. The Compliance and Reporting Layer ensures that the smart contract wallet 117 adheres to regulatory standards. It is equipped with features for identity verification, generating reports for regulatory authorities, and incorporating logic designed to detect and prevent illicit activities, such as wash trading. The Integration Layer enables the smart contract wallet 117 to connect with external systems and services. This may include third-party cryptocurrency exchanges, decentralized finance (DeFi) protocols, and identity verification services. The integration is facilitated through the use of APIs and other mechanisms.

Finally, in scenarios where the smart contract wallet 117 interacts with privacy-centric cryptocurrencies and external sources of information, the Oracles Layer comes into play. As an instance, this layer may consist of decentralized oracles that equip the wallet with the capability to verify transactions using data from outside the smart contract.

For Monero, which utilizes ring signatures and stealth addresses to obfuscate transaction details, the system may employ ZKPs to confirm that a transaction complies with regulatory requirements without disclosing the identities of the sender and recipient or the transaction amount. The ZKP can be constructed in such a way that it validates the transaction against a set of compliance rules, such as ensuring that the sender and recipient are not on any sanction lists or involved in illegal activities, without revealing any underlying transaction data.

The programming architecture for implementing ZKPs in smart contracts may involve the use of precompiled contracts or cryptographic libraries that support ZKP protocols. These precompiled contracts or libraries can be integrated into the smart contract code, enabling it to generate and verify zero-knowledge proofs. The smart contract may be written in a programming language suitable for blockchain development, such as Solidity, and may include functions to interact with the ZKP components.

The programming architecture for SMPC may include the use of off-chain computation nodes that perform the SMPC protocol. The compliance smart contract would communicate with these nodes, sending encrypted transaction data and receiving a proof of compliance. The smart contract would then validate the proof on-chain to complete the compliance check.

In both architectures, the compliance smart contract may also include mechanisms for handling exceptions and disputes. For example, if a transaction is flagged as non-compliant, the smart contract may provide a process for the parties involved to submit additional information or challenge the decision.

According to another aspect of the present disclosure, the system may further comprise a smart contract wallet 117, wherein both the user 1001 and the platform have access to the wallet, and the platform can withdraw assets from third party crypto exchanges.

According to another aspect of the present disclosure, a method is provided for enforcing compliance in secondary trading of financial assets on a blockchain. The method includes receiving a request to transfer an ERC-20 standard digital asset from a sender to a recipient, verifying the registration status of the recipient or the signer with a platform, and if the registration status is verified, executing the transfer of the digital asset. If the registration status is not verified, the transfer of the digital asset is blocked.

According to other aspects of the present disclosure, the method may further include the step of detecting and blocking the use of asset proxying mechanisms such as wrapper contracts based on trading activity. The registration status may be verified by checking a separate ERC-721 contract representing the identity of the recipient or the signer. The blockchain network 101 may be one of Ethereum, Arbitrum, Optimism, Base, Polygon, Avalanche, Binance chain, Tron, Linea, Kava, Solana, Blast, Algorand, ICP, Fantom, Metis, Polygon zkEVM, ZKsync Era, Aptos or any EVM or smart contract technology compatible chains. The method may further include the step of enforcing geographical restrictions on the transfer of the digital asset to prevent breach of securities laws. The detection of wrapper contracts may be based on an algorithm that analyzes trading activity. The method may further include the step of blocking the transfer of the digital asset if the recipient or the signer is engaged in illegal activities such as wash trading or tax avoidance.

To provide more detailed support for the claim element regarding the detection of asset proxying mechanisms such as wrapper contracts through an algorithm that conducts a thorough analysis of trading activities, we can add the following disclosure:

The system employs a sophisticated algorithm to detect the use of asset proxying mechanisms such as wrapper contracts by conducting a comprehensive analysis of trading activities. This algorithm operates in multiple stages, combining various analytical techniques to identify patterns and behaviors indicative of wrapper contract usage. In the first stage, the algorithm performs a transaction graph analysis. It constructs a directed graph where nodes represent smart contracts or user 1001 addresses, and edges represent transactions or contract calls. The algorithm then analyzes this graph to identify suspicious structures, such as circular dependencies, abnormal call depths, and fan-in/fan-out patterns.

In the second stage, the algorithm employs temporal pattern recognition. It examines the timing and frequency of transactions involving suspected wrapper contracts. This analysis may include burst detection, periodic behavior recognition, and sequence analysis. The third stage involves anomaly detection based on historical data. The algorithm establishes baseline behaviors for normal contract interactions and flags deviations from these norms. This may include volume anomalies, value discrepancies, and interaction pattern changes.

In the fourth stage, the algorithm utilizes machine learning techniques to classify contracts and transactions. This may involve feature extraction, model training using supervised learning algorithms, and classification of new contracts and transactions to identify potential asset proxying. The fifth stage incorporates clustering analysis to group similar contracts and transactions. This helps identify coordinated activities that may involve multiple asset proxying techniques. The clustering may be based on transaction characteristics, code similarity, and interaction networks.

Throughout these stages, the algorithm maintains a dynamic risk scoring system. Each contract and transaction is assigned a risk score based on the cumulative results of the various analyses. Contracts or transactions exceeding risk thresholds are flagged for further investigation or automatic blocking. The algorithm also incorporates a feedback loop mechanism. As new asset proxying techniques are identified and confirmed, this information is fed back into the system to update the detection models and improve future accuracy.

To handle the large volume of data and ensure real-time detection, the algorithm may employ distributed computing techniques. It may partition the blockchain data across multiple nodes, allowing parallel processing of different segments of the transaction history. The algorithm is designed to be adaptable and self-improving. It regularly retrains its models using newly acquired data and adjusts its parameters based on the effectiveness of its detections. This ensures that the system remains effective against evolving techniques for creating and using wrapper contracts.

The computer-implemented method encompasses an approach to maintaining the integrity of financial transactions on the blockchain by detecting and preventing the use of wrapper contracts. This is achieved through a comprehensive analysis of trading patterns 210 conducted by the computing system.

The computing system is configured with analytical capabilities to scrutinize the trading patterns on the blockchain. It examines a multitude of transaction attributes, such as the frequency of interactions between contracts, the volume and size of transactions, the sequence of contract calls, and the flow of assets between accounts. By analyzing these patterns, the computing system can detect irregularities that may suggest the use of wrapper contracts.

Asset proxying mechanisms are typically used to add layers of interaction over the primary smart contracts, which can be exploited to bypass established rules or controls. The computing system identifies these mechanisms by looking for specific indicators within the trading patterns. For instance, a sudden increase in transaction volume involving a new contract or a pattern of transactions that systematically avoids regular compliance checks 1005 could signal the use of a wrapper contract.

The system may employ various algorithms to detect wrapper contracts, such as graph analysis algorithms, temporal pattern recognition, machine learning models, anomaly detection algorithms, and clustering algorithms.

Upon identifying a potential asset proxy, the computing system initiates preventive measures to mitigate any risk posed by the contract. These measures can include temporarily halting transactions from the suspected contracts and adjacent other employed systems, alerting system administrators to conduct a manual review, or automatically enforcing additional verification steps before allowing further transactions.

The detection and prevention mechanism is seamlessly integrated with the smart contract protocols of the blockchain platform. The computing system's analysis is designed to complement the smart contract logic, ensuring that any attempt to use wrapper contracts is identified and addressed without disrupting legitimate transactions.

To enhance the detection process, the computing system may employ machine learning algorithms that have been trained on historical blockchain data to recognize wrapper contract usage. Additionally, heuristic-based algorithms can be used to apply a set of predefined rules to transaction data, flagging any activity that matches known patterns of wrapper contract behavior.

The computing system's analysis is not limited to real-time transactions; it also encompasses historical data. By maintaining a comprehensive view of past and present trading activities, the system can identify emerging trends and adapt its detection algorithms accordingly.

The method ensures that users remain compliant with regulatory standards by preventing the use of asset proxying that could obscure the true nature of transactions. The computing system's analysis helps maintain transparency and adherence to regulations such as anti-money laundering (AML) and know your customer (KYC) requirements.

The computer-implemented method encompasses an approach to maintaining the integrity of financial transactions on the blockchain by detecting and preventing the use of asset proxying. This is achieved through a comprehensive analysis of trading patterns 210 conducted by the computing system.

The computing system is configured with analytical capabilities to scrutinize the trading patterns on the blockchain. It examines a multitude of transaction attributes, such as the frequency of interactions between contracts, the volume and size of transactions, the sequence of contract calls, and the flow of assets between accounts. By analyzing these patterns, the computing system can detect irregularities that may suggest the use of asset proxying.

Wrapper contracts are typically used to add layers of interaction over the primary smart contracts, which can be exploited to bypass established rules or controls. The computing system identifies these wrapper contracts by looking for specific indicators within the trading patterns. For instance, a sudden increase in transaction volume involving a new contract or a pattern of transactions that systematically avoids regular compliance checks 1005 could signal the use of asset proxying techniques.

Upon identifying a potential asset proxying implementation, the computing system initiates preventive measures to mitigate any risk posed by the asset proxying implementation. These measures can include temporarily halting transactions from the suspected addresses or contracts involved in the asset proxying, alerting system administrators to conduct a manual review, or automatically enforcing additional verification steps before allowing further transactions.

The detection and prevention mechanism is seamlessly integrated with the smart contract protocols of the blockchain platform. The computing system's analysis is designed to complement the smart contract logic, ensuring that any attempt to employ asset proxying techniques is identified and addressed without disrupting legitimate transactions.

To enhance the detection process, the computing system may employ machine learning algorithms that have been trained on historical blockchain data to recognize the hallmarks of asset proxying usage. Additionally, heuristic-based algorithms can be used to apply a set of predefined rules to transaction data, flagging any activity that matches known patterns of asset proxying behavior.

The computing system's analysis is not limited to real-time transactions; it also encompasses historical data. By maintaining a comprehensive view of past and present trading activities, the system can identify emerging trends and adapt its detection algorithms accordingly.

The method ensures that users remain compliant with regulatory standards by preventing the use of asset proxying mechanisms that could obscure the true nature of transactions. The computing system's analysis helps maintain transparency and adherence to regulations such as anti-money laundering (AML) and know your customer (KYC) requirements.

The computing system is designed to adapt to changes in trading behavior and the evolution of asset proxying techniques. It continuously improves its analytical models and updates its detection algorithms to stay ahead of new methods that may be employed to circumvent platform rules.

According to another aspect of the present disclosure, a computer-readable medium is provided storing instructions that, when executed by a processor, cause the processor to receive a request to transfer an ERC-20 standard digital asset from a sender to a recipient on a blockchain, verify the registration status of the recipient or the signer with a platform, and if the registration status is verified, execute the transfer of the digital asset. If the registration status is not verified, the transfer of the digital asset is blocked.

According to other aspects of the present disclosure, the registration status may be verified by checking a separate set of contracts representing the identity of the recipient or the signer, and which may implement the ERC-721 or ERC-1155 standard. The instructions may further cause the processor to detect and block the use of asset proxying based on trading activity. The instructions may further cause the processor to enforce geographical restrictions on the transfer of the digital asset to prevent breach of securities laws. The blockchain network 101 may be one of Ethereum, Arbitrum, Optimism, Base, Polygon, Avalanche, Binance chain, Tron, Linea, Kava, Solana, Blast, Algorand, ICP, Fantom, Metis, Polygon zkEVM, ZKsync Era, Aptos or any EVM or smart contract technology compatible chains. The instructions may further cause the processor to block the transfer of the digital asset if the recipient or the signer is engaged in illegal activities such as wash trading or tax avoidance.

In some embodiments, the present disclosure may include a system and method for analyzing transactions and assessing risk associated with non-Ethereum Virtual Machine (non-EVM) compliant cryptocurrencies or blockchains, such as Bitcoin. This embodiment may be particularly tailored to address the nuances and specific characteristics of non-EVM compliant cryptocurrencies and non-EVM compliant blockchains, which do not operate on the same principles as EVM-compliant blockchains like Ethereum.

The system may include a specialized blockchain analysis tool configured to interact with non-EVM compliant blockchains. This tool may be capable of parsing and interpreting the distinct transaction scripts and structures used in non-EVM blockchains, such as the Unspent Transaction Output (UTXO) model employed by Bitcoin. The analysis tool may extract relevant data from transaction inputs and outputs, assess the transaction graph, and apply algorithms to detect patterns indicative of money laundering or other illicit activities.

In some cases, the system may employ a heuristic analysis module configured to identify clustering of addresses or wallets that may suggest control by a single entity or associated group. This module may use various heuristics, such as common spending patterns or shared transaction attributes, to infer connections between seemingly unrelated addresses.

Additionally, the system may include a risk assessment module configured to evaluate transactions based on criteria specific to non-EVM compliant cryptocurrencies and non-EVM compliant blockchains. For instance, the module may assess the risk level of transactions with a higher degree of anonymity features, such as those utilizing mixing services or privacy-focused wallet implementations.

The embodiment may further comprise an integration module configured to interface with external data sources, such as public keys or metadata associated with non-EVM compliant blockchain transactions. This module may facilitate the cross-referencing of transaction data with off-chain information, enhancing the system's ability to perform comprehensive risk assessments.

Moreover, the system may utilize an anomaly detection module 103 configured to apply machine learning algorithms to transaction data from non-EVM compliant blockchains. This module may be trained on historical data to recognize patterns of normal and suspicious behavior, thereby improving the system's capability to detect anomalous transactions that may warrant further investigation.

In some aspects, the system may also include a reporting module configured to generate compliance reports based on the analysis of non-EVM compliant cryptocurrency transactions. These reports may be structured to satisfy the specific regulatory requirements applicable to non-EVM compliant cryptocurrencies, aiding institutions in maintaining compliance with AML/KYC regulations.

In one embodiment, the present disclosure provides a blockchain-based system designed to enforce compliance in secondary trading of financial assets. In one embodiment of the invention, this system is built upon the ERC-20 standard, a widely adopted smart contract standard in the blockchain space and introduces modifications to enhance the security and efficiency of asset transactions. The system addresses the limitations of secondary trading on open platforms by inventing a method to enforce holders to be registered with a platform, while simultaneously allowing for secondary trading and liquidity. This is achieved by modifying the transfer function of the ERC-20 standard to check that either the recipient of the asset is an end-wallet registered with the platform, or if it's a contract, the signer is registered with the platform.

In some aspects, the system may include a Know Your Customer (KYC) and registration process facilitated by the registration module 102, which is designed to collect and verify information from users who wish to engage in secondary trading of financial assets on the platform. The KYC and registration process is a mandatory step for all users to ensure compliance with regulatory requirements and to prevent illicit activities such as money laundering and fraud. For the first transaction when buying an asset for example, KYC could be minimal or skipped in order to incentivize new user's to sign up, while requiring KYC to sell or transfer the asset.

During the KYC and registration process, users may be requested to provide personal information, which may include, but is not limited to, their full name, date of birth, address, contact details, and a valid government-issued identification document such as a passport or driver's license. Users may also be asked to provide financial information, such as their source of funds or wealth, to ensure the legitimacy of the assets being traded.

The registration module 102 may use various methods to verify the authenticity of the information provided by users. These methods may include document verification, biometric verification, database 1106 screening against known or suspected money launderers and terrorists, and electronic identity verification services that cross-reference personal information with electronic records.

Once the user's information is verified, the registration module 102 may create a digital identity for the user 1001, which may be represented by a separate set of contracts that may implement standards such as ERC-721 and ERC-1155. This digital identity serves as proof of the user's registration status with the platform and may be used during transactions to verify that the user 1001 is compliant with the platform's requirements.

As used herein, the term “ERC-721 contract” refers to a type of smart contract on the Ethereum blockchain 1104 that adheres to the ERC-721 standard. The ERC-721 standard, also known as the Non-Fungible Token (NFT) standard, defines a set of rules and functions for creating and managing non-fungible tokens on the Ethereum blockchain 1104. Non-fungible tokens are digital assets that are uniquely identifiable and not interchangeable with other tokens. An ERC-721 contract may include functions for transferring tokens, querying the ownership of tokens, and enumerating tokens owned by an address. In the context of the present system, an ERC-721 contract may be used to represent the identity of a user 1001 or wallet in a secure and verifiable manner.

Within the framework of the current system, an ERC-721 contract, known for its ability to issue non-fungible tokens (NFTs), may be utilized to securely and verifiably represent a user's or wallet's identity. However, this is just one of the many approaches that can be taken.

With ERC-1155 contracts, the computer system, more specifically the central processing unit (CPU) of the computer system, is tasked with executing smart contracts that are uniquely capable of managing both fungible assets, such as cryptocurrencies, and non-fungible assets, like digital collectibles, within a unified contractual framework. The arithmetic logic unit (ALU) of the CPU is responsible for the computations involved in issuing, transferring, and managing these different token types, adhering to the rules set forth in the ERC-1155 standard. The system's memory plays a role in temporarily storing the state of each token, encompassing ownership details and transaction histories, while the cache system ensures that this data can be accessed swiftly during transaction processing. Long term storage of information related to each token can be done through the use of a database 1106 or hard drive.

When it comes to integrating with external identity verification services, the computer system establishes secure communication channels under the management of the CPU. The ALU processes the incoming data from these services, which may include biometric scans or document validation outcomes, to authenticate user 1001 identities. The results of these verifications, along with user 1001 credentials, are stored in memory, and the cache allows for their quick retrieval, particularly when such data is in high demand.

Decentralized Identifiers (DIDs) are another aspect of the system, with the CPU interacting with blockchain networks that support DIDs to register and manage decentralized identities. The ALU is charged with the cryptographic operations linked to DIDs, such as the generation and verification of digital signatures that securely associate users with their digital assets. Memory maintains the DID records, and the cache aids in providing expedited access to these records, which is especially useful during identity checks or when transferring assets.

For transactions requiring heightened security, the system can employ multi-signature wallets, executed by the CPU, which necessitate authorization from multiple private keys to proceed. The ALU confirms that the requisite number of signatures is present before allowing a transaction to go forward. Details of each signatory and the status of transactions awaiting approval are stored in memory, with the cache facilitating the swift verification of multi-signatures.

Smart contract wallets, which incorporate complex logic for identity verification, are also executed by the CPU. The ALU processes this embedded logic, which may include conditional checks and additional security protocols. User 1001 identity information and the logic governing the smart contract wallets are stored in memory, with the cache ensuring efficient access during transactional activities.

Lastly, the system can utilize proxy contracts which act as intermediaries for other contracts. This allows for the underlying contracts to be upgraded or modified without impacting the user's established identity. The ALU directs calls from the proxy contract to the appropriate underlying contract and manages any specific data transformations or logic. Memory stores the relationship between proxy contracts and their underlying contracts, as well as any relevant user 1001 identity state information. The cache ensures that this information is readily accessible, particularly when proxy contracts are engaged frequently.

Lastly, a layered approach to identity verification could be employed, where multiple verification methods are used in tandem to confirm the identity of a user 1001 or wallet. This multifaceted strategy can provide a more secure and robust defense against fraudulent activities and identity theft.

One component of this architecture is the User Interface 1101 (UI) Layer, which serves as the front-end platform for user 1001 interaction. Through this layer, users can register, manage their assets, and input personal details. It includes web pages that facilitate the entry of personal data, the uploading of documents for KYC purposes, and the management of digital asset transactions. The UI layer is designed to seamlessly communicate with backend systems, processing user 1001 requests and presenting pertinent information.

The Application Logic Layer houses the business logic central to the system's operations. It manages the processes for user 1001 registration, KYC verification, digital identity creation, and compliance checks 1005. This layer acts as a conductor, directing the flow of data between the UI layer and the Data Storage Layer, ensuring that user 1001 inputs lead to the correct system actions. The Data Storage Layer is tasked with the secure management of user 1001 information, KYC documentation, digital identities, and transaction logs. It may employ secure and private databases, such as encrypted databases or blockchain-based storage systems, to safeguard sensitive data. This layer is responsible for maintaining the integrity and confidentiality of stored data, making it available for verification and audit processes when necessitated.

Lastly, the Smart Contract Generation and Management Layer oversees the creation, deployment, and administration of smart contracts on the blockchain. This layer is equipped with tools and services designed to produce ERC-20 and ERC-721 contracts, as well as bespoke contracts tailored to specific requirements. It ensures that smart contracts are crafted accurately, comply with the system's standards, and adhere to the protocols of the underlying blockchain infrastructure.

The Smart Contract Generation and Management Layer is a core component of the blockchain-based system that facilitates the creation, deployment, and management of smart contracts. Smart contracts are self-executing contracts with the terms of the agreement directly written into code, which run on a blockchain network 101. This layer provides a suite of development tools and services that enable developers to write, test, and deploy smart contracts that are tailored to specific use cases and compliant with the system's requirements.

In technical terms, this layer may include integrated development environments (IDEs), frameworks, and libraries that support the Solidity programming language, which is commonly used for writing smart contracts on Ethereum-based blockchains. The layer may also provide version control systems to manage changes to the contract code, automated testing tools to ensure the correctness of the smart contracts, and deployment scripts to facilitate the migration of smart contracts to the blockchain.

For instance, the Truffle Suite is a popular framework that could be included in this layer to assist developers in creating and managing smart contracts. It includes a development environment, testing framework, and asset pipeline for blockchains using the Ethereum Virtual Machine (EVM)

The Smart Contract Generation and Management Layer would also handle the generation of ERC-721 contracts for non-fungible tokens (NFTs). These contracts would include functions to mint, transfer, and manage ownership of NFTs. Additionally, the layer could support the creation of custom contracts that may include complex logic, such as compliance checks 1005, voting mechanisms, or decentralized finance (DeFi) applications.

While wrapper contracts can provide additional functionality, they can also be used to circumvent restrictions or controls put in place by the original contract.

In some aspects, the system may employ algorithms to detect the use of asset proxying mechanisms like wrapper contracts, which are smart contracts. These algorithms may analyze patterns of contract interactions to identify characteristics that are indicative of asset proxying.

One approach to detecting asset proxying may involve the analysis of transaction graphs. A transaction graph is a representation of the flow of transactions between different accounts and contracts on the blockchain. In this graph, nodes represent accounts or contracts, and edges represent transactions between them. An algorithm may analyze the topology of the transaction graph to identify subgraphs that are characteristic of wrapper contract usage. For example, a subgraph showing a cyclical pattern of interactions between a set of contracts may suggest the presence of a wrapper contract.

Another approach may involve the use of machine learning models trained on historical data to identify asset proxying. These models can be trained to recognize the signatures of asset proxying techniques transactions based on features such as the frequency of contract interactions, the types of functions called, and the sequence of actions performed by the contracts. For instance, a supervised learning model such as a neural network could be trained on labeled data sets where the labels indicate whether a contract is an asset proxy or not.

Statistical algorithms may also be used to detect anomalies in contract interactions that could indicate the use of asset proxying techniques. For example, a contract that frequently interacts with other contracts in a manner that deviates from the norm may be flagged as a potential asset proxy contract. Statistical measures such as Z-scores or Grubbs'test can be applied to the frequency and volume of transactions associated with a contract to identify outliers.

In some cases, the detection of asset proxy contracts may involve the use of formal verification techniques to analyze the bytecode of smart contracts. Formal verification involves the use of mathematical methods to prove or disprove the correctness of algorithms underlying a system. By applying formal verification to the bytecode of smart contracts, it may be possible to identify contracts that are designed to function as asset proxies by verifying whether their code contains patterns or logic that are typical of asset proxy or wrapper contracts.

The system may incorporate a combination of these algorithms and methods to enhance its ability to detect and block the use of asset proxying mechanisms. By analyzing transaction graphs, applying machine learning models, utilizing statistical algorithms, and employing formal verification techniques, the system can provide a robust mechanism for identifying and mitigating the risks associated with asset proxying mechanisms in the trading of financial assets on blockchain platforms.

Additionally, the system includes detection module 103 configured to identify and inhibit illegal activities including wash trading and tax avoidance. This detection module 103 is further configured to employ a specific algorithm designed to detect wash trading by analyzing trading patterns and volume.

According to other aspects of the present disclosure, the system may include additional features. The registration module 102 may be further configured to compile a deny list 115 of wallets implicated in wash trading along with all their associated assets, and to update the deny list 115 in response to alterations in trading behavior or changes in regulatory requirements.

The detection module 103 may be further configured to identify wash trading utilizing a Pareto-Levy test, wherein a user 1001 accounting for 10% of the trading volume for a particular exchange is deemed to be engaging in wash trading, and to incorporate additional algorithms to enhance the detection of wash trading patterns.

The detection module 103 within the blockchain-based compliance system includes an algorithm that is executed by a processor to identify potential wash trading activities. This algorithm employs the Pareto-Levy test, a statistical method that is particularly effective in detecting disproportionate trading activities that may indicate market manipulation.

The processor is a central computing unit responsible for executing the algorithm that applies the Pareto-Levy test to trading data. The processor is configured to handle complex computations and is capable of processing large datasets with high efficiency. It is tasked with analyzing the trading volumes across various users on an exchange to identify any anomalous patterns that deviate from typical market behavior.

The algorithm executed by the processor begins by collecting trading volume data from the blockchain network 101. It then calculates the percentage of the total trading volume that each user 1001 accounts for within a specific timeframe. By applying the Pareto-Levy test, the algorithm assesses whether the distribution of trading volumes follows a pattern that could be expected under normal market conditions or if there are outliers that suggest potential wash trading.

A user 1001 is characterized as engaging in wash trading if the algorithm determines that they are responsible for 10% or more of the total trading volume on a given exchange. This threshold is set based on the assumption that such a high concentration of trades by a single user 1001 is unlikely to be a result of legitimate trading strategies and may instead be indicative of an attempt to manipulate the market.

The processor is capable of performing this analysis in real-time, allowing the detection module 103 to actively monitor ongoing trading activities. This real-time analysis is instrumental in promptly identifying and addressing wash trading, thereby preventing the manipulation from affecting the market's integrity.

Upon identifying a user 1001 that meets the criteria for wash trading, the processor communicates this finding to other components of the system, such as the registration module 102. The registration module 102 can then take appropriate actions, which may include adding the implicated wallet to the deny list 115, initiating a detailed investigation, or implementing measures to mitigate the impact of the identified wash trading.

The algorithm executed by the processor is designed to be adaptable to different market sizes and conditions. The 10% threshold used in the Pareto-Levy test can be calibrated to ensure that the algorithm remains sensitive to the nuances of different exchanges and is aligned with evolving regulatory standards.

The processor also plays a role in documenting instances of wash trading detected by the algorithm. It ensures that all relevant data and analysis results are securely stored, providing a basis for regulatory reporting and evidence in case of legal proceedings.

The detection module 103 is an integral component of the blockchain-based compliance system, designed to proactively identify and prevent illegal activities such as wash trading and tax avoidance. The module can be implemented by a processor and memory that work in tandem to execute sophisticated algorithms and heuristics tailored to monitor and analyze transaction patterns on the blockchain.

The processor within the detection module 103 is a computational unit responsible for executing the instructions that are stored in the associated memory. It is capable of handling complex data processing tasks at high speeds, which is paramount for real-time analysis of blockchain transactions. The processor may be a general-purpose CPU or a specialized processing unit such as a digital signal processor (DSP) or an application-specific integrated circuit (ASIC) optimized for cryptographic and data analysis operations.

The memory component of the detection module 103 serves as a repository for the instructions that the processor executes, as well as the data that is analyzed. This memory may include both volatile memory, such as RAM, for temporary storage of transaction data and non-volatile memory, such as flash memory or SSDs, for long-term storage of historical transaction data and analysis results. The memory is structured to allow for efficient access and retrieval of data, enabling the processor to perform its tasks without undue delay.

The detection module 103 employs a range of algorithms to identify patterns and behaviors indicative of illegal activities. For wash trading detection, the module analyzes the volume and frequency of trades from individual accounts, looking for self-dealing or circular trading patterns that suggest artificial market manipulation. The module may also use machine learning models trained on historical trading data to predict and identify suspicious trading behaviors.

For tax avoidance detection, the module examines transaction records for patterns that may indicate attempts to evade tax obligations. This could include analyzing the timing and size of transactions, the use of specific financial instruments, or the transfer of assets to jurisdictions with lower tax rates. The module may also cross-reference transaction data against tax reporting data to identify discrepancies.

Upon identifying a potential illegal activity, the detection module 103 takes proactive measures to prevent the activity from continuing. This may involve alerting regulatory authorities, flagging associated accounts for further investigation, or automatically triggering smart contract functions that restrict or reverse the suspicious transactions. The module may also update a deny list 115 of wallets and accounts that have been implicated in illegal activities, preventing them from participating in future transactions on the platform.

The detection module 103 is designed to adapt to evolving regulatory requirements and emerging patterns of financial crime. The memory component can be updated with new instructions and algorithms as new threats are identified, ensuring that the module remains effective over time. The processor's ability to execute updated instructions allows the module to respond quickly to changes in the regulatory landscape or advancements in illegal activity strategies.

The detection module 103 may employ encryption and access control mechanisms to ensure that sensitive data is not exposed during the detection process.

The blockchain network 101 may be compatible with a diverse array of blockchains, including but not limited to Ethereum, Arbitrum, Optimism, Base, Polygon, Avalanche, Binance chain, Tron, Linea, Kava, Solana, Blast, Algorand, ICP, Fantom, Metis, Polygon zkEVM, ZKsync Era, Aptos and all chains compatible with the Ethereum Virtual Machine (EVM) or smart contract technology. The system may be further configured to adapt to evolving regulatory requirements across various jurisdictions.

The modified transfer function 111 may be further configured to impose restrictions on the transfer of the digital asset based on geographical location, thereby averting breaches of securities laws by disabling sales to countries where such trade is prohibited, and to enforce additional restrictions based on transaction patterns and regulatory compliance lists.

The system may further comprise a smart contract wallet 117, wherein both the user 1001 and the platform are granted access to the wallet, and the platform is authorized to withdraw assets from third-party cryptocurrency exchanges. The smart contract wallet 117 may be further configured to facilitate transactions while preserving the privacy and anonymity features inherent to blockchain transactions.

The computer-based system includes a smart contract wallet 117 that is designed to be accessible by both the user 1001 and the platform. This wallet is a secure digital storage mechanism that holds digital assets and is integrated into the blockchain network 101. A defining feature of this smart contract wallet 117 is the authorization granted to the platform to withdraw assets from third-party cryptocurrency exchanges either on behalf of the user 1001 or to restrict the user's access due to failures to comply with KYC/AML regulations.

The smart contract wallet 117 is structured to allow both the user 1001 and the platform to access and manage the assets contained within it. Users can interact with the wallet to perform transactions such as deposits, transfers, and withdrawals. The platform, on the other hand, has specific permissions that enable it to manage the assets in the wallet according to predefined rules and conditions set forth in the smart contract.

One of the permissions granted to the platform is the authority to initiate withdrawals of assets from third-party cryptocurrency exchanges. This authorization is encoded within the smart contract that governs the operation of the wallet. The smart contract includes functions that the platform can invoke to transfer assets from the exchange to the smart contract wallet 117.

The mechanism for authorizing the platform to withdraw assets is based on a set of cryptographic keys and permissions. The platform holds a set of keys or credentials that allow it to authenticate with the third-party exchange and request the withdrawal of assets. The exchange, recognizing the platform's authorization through the smart contract, processes the withdrawal request and transfers the assets to the smart contract wallet 117.

To ensure the security of transactions, the smart contract wallet 117 incorporates multiple layers of protection. These measures include encryption of the wallet's contents, secure signing of transactions, and verification processes to confirm the legitimacy of withdrawal requests. The platform's withdrawal activities are logged and monitored to prevent unauthorized access or fraudulent transactions.

The authorization for the platform to withdraw assets is designed to comply with regulatory requirements. The smart contract wallet 117 can enforce compliance checks 1005 before executing a withdrawal, ensuring that the transaction adheres to anti-money laundering (AML) and Know Your Customer (KYC) regulations. The wallet can also be programmed to restrict withdrawals to or from jurisdictions where such transactions are prohibited by law.

According to another aspect of the present disclosure, a method for enforcing compliance in secondary trading of financial assets on a blockchain is provided. The method includes receiving a request to transfer a digital asset compliant with the ERC-20 standard from a sender to a recipient, verifying the registration status of the recipient or the signer with a platform by referencing a registry of registered asset holders and a separate set of contracts that may implement ERC-721 and ERC-1155 standards that represents the identity of the recipient or the signer, executing the transfer of the digital asset upon confirmation of the registration status, and blocking the transfer of the digital asset if the registration status is not verified. The method also includes detecting and inhibiting the utilization of wrapper contracts based on trading activity and an algorithm that scrutinizes trading patterns.

By embedding these compliance checks 1005 directly into the transfer function of the ERC-20 standard smart contract, the system ensures that every transaction adheres to regulatory requirements.

For privacy coins such as Monero or ZCash, which prioritize anonymity and privacy, potential embodiments of the system may involve adapting the compliance enforcement mechanisms to work within the constraints of these blockchains'privacy features. Monero uses ring signatures and stealth addresses to obfuscate transaction details, while ZCash employs zk-SNARKs to enable private transactions. To integrate with such privacy-focused blockchains, the system may utilize cryptographic techniques that allow for compliance checks 1005.

The system may also include a user interface 1101 that guides users through the KYC and registration process, providing instructions and assistance. The interface may allow users to upload the requested documents and information securely and may provide real-time feedback on the status of their registration. Upon successful completion of the KYC and registration process, users may be granted access to the platform's services, including the ability to engage in secondary trading of financial assets. The system may record the user's registration status on the blockchain, ensuring that it is immutable and transparent. The system's detection module 103 may continuously monitor trading activity to identify and block any transactions that involve unregistered users or users who have been denylisted due to engagement in illegal activities.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

1. A computer-based system for enforcing compliance in secondary market trading of financial assets, comprising:
a blockchain network configured to facilitate the creation and transfer of digital assets adhering to the ERC-20 standard;
a registration module comprising a processor and memory, the processor executing instructions stored in the memory to require asset holders to register with a designated platform;
a modified transfer function within the ERC-20 standard smart contract, the function including code executed by the blockchain network to verify the registration status of asset recipients and signers; and
a detection module comprising a processor and memory, the processor executing instructions stored in the memory to proactively identify and prevent illegal activities, including but not limited to wash trading and tax avoidance.

2. The computer-based system of claim 1, wherein the registration module further comprises a database to compile and maintain a deny list of wallets implicated in illegal or unauthorized activities including but not limited to wash trading, tax avoidance, asset proxying, and market manipulation along with any associated assets.

3. The computer-based system of claim 2, wherein the detection module further comprises an algorithm executed by the processor to identify wash trading; such as using a Pareto-Levy test, characterizing a user as engaging in wash trading if they account for 10% or more of the trading volume on a given exchange.

4. The computer-based system of claim 1, wherein the blockchain network is compatible with a diverse array of blockchain platforms, including Ethereum, Arbitrum, Optimism, Base, Polygon, Avalanche, Binance Chain, Tron, Linea, Kava, Solana, Algorand, ICP, Fantom, Metis, Polygon zkEVM, ZKsync Era, Aptos and any network that is compatible with Ethereum Virtual Machine (EVM) or smart contract technology.

5. The computer-based system of claim 1, wherein the modified transfer function further comprises code executed by the blockchain network to impose transfer restrictions based on geographical location, effectively preventing the sale of digital assets to regions where such transactions are prohibited by securities law.

6. The computer-based system of claim 1, further comprising a smart contract wallet accessible to both the user and the platform, with the platform authorized to withdraw assets from third-party cryptocurrency exchanges.

7. A computer-implemented method for enforcing compliance in secondary market trading of financial assets on a blockchain, comprising:
receiving, by a computing system, a transfer request for an ERC-20 standard digital asset from a sender to a recipient;
verifying, by the computing system, the registration status of the recipient or the signer with a platform;
executing, by the computing system, the asset transfer upon confirmation of verified registration status; and
blocking, by the computing system, the asset transfer if the registration status is unverified.

8. The computer-implemented method of claim 7, further comprising detecting and preventing the use of asset proxying mechanisms including but not limited to wrapper contracts based on an analysis of trading patterns by the computing system.

9. The computer-implemented method of claim 7, wherein the verification of registration status is conducted by examining a distinct set of contracts that may implement ERC-721 and ERC-1155 standards representing the identity of the recipient or the signer.

10. The computer-implemented method of claim 7, applicable to a blockchain network selected from a group comprising Ethereum, Arbitrum, Optimism, Base, Polygon, Avalanche, Binance chain, Tron, Linea, Kava, Solana, Blast, Algorand, ICP, Fantom, Metis, Polygon zkEVM, ZKsync Era, Aptos and any EVM or smart contract technology compatible chains.

11. The computer-implemented method of claim 7, further including enforcing geographical restrictions on the digital asset transfer by the computing system, thereby upholding securities laws and preventing unauthorized trades in specific regions.

12. The computer-implemented method of claim 8, wherein the identification of asset proxying is executed through an algorithm that conducts a thorough analysis of trading activities by the computing system.

13. The computer-implemented method of claim 7, further including blocking the digital asset transfer by the computing system if the recipient or the signer is implicated in illegal activities, such as wash trading or tax avoidance.

14. A computer-readable medium containing instructions that, when executed by a processor, lead to:
the receipt of a transfer request for an ERC-20 standard digital asset from a sender to a recipient on a blockchain;
the verification of the recipient's or signer's registration status with a platform;
the execution of the digital asset transfer upon verification of registration status; and
the blocking of the digital asset transfer if the registration status is unverified.

15. The computer-readable medium of claim 14, where the verification of registration status is achieved by examining a distinct set of contracts that may implement ERC-721 and ERC-1155 standards symbolizing the identity of the recipient or the signer.

16. The computer-readable medium of claim 14, with instructions that further lead the processor to detect and prevent the use of asset proxying mechanisms including but not limited to wrapper contracts through an analysis of trading activities.

17. The computer-readable medium of claim 16, where the detection of asset proxying is executed by an algorithm specifically designed to analyze trading activities.

18. The computer-readable medium of claim 14, with instructions that further lead the processor to enforce geographical restrictions on the transfer of the digital asset, thereby ensuring compliance with securities laws.

19. The computer-readable medium of claim 14, where the blockchain network is selected from a group that includes Ethereum, Arbitrum, Optimism, Base, Polygon, Avalanche, Binance chain, Tron, Linea, Kava, Solana, Blast, Algorand, ICP, Fantom, Metis, Polygon zkEVM, ZKsync Era, Aptos and any EVM-compatible or smart contract technology compatible chains.

20. The computer-readable medium of claim 14, with instructions that further lead the processor to block the transfer of the digital asset if the recipient or the signer is found to be engaged in illegal activities, such as wash trading or tax evasion.
